(19) United States
(12) Patent Application Publication
(10) Pub. No.: US 2025/0019258 A1
(43) Pub. Date: Jan. 16, 2025

(54) Layered Sodium Metal Oxides For Na-ion Batteries

(71) Applicant: University Court of the University of St. Andrews, St. Andrews (GB)

(72) Inventors: Anthony Robert Armstrong, St. Andrews (GB); Philip Adam Maughan, St. Andrews (GB)

(73) Assignee: University Court of the University of St. Andrews, St. Andrews (GB)

(21) Appl. No.: 18/708,878

(22) PCT Filed: Oct. 18, 2022
(86) PCT No.: PCT/GB2022/052656

§ 371 Date: May 9, 2024

(30) Foreign Application Priority Data
Nov. 11, 2021 (GB) 2116256.5

(51) Int. Cl. C01G 49/00; H01M 10/054

(52) U.S. Cl. CPC C01G 49/0018; H01M 10/054; C01P 2002/72; C01P 2002/76; C01P 2004/82; C01P 2006/40

(57) ABSTRACT

A composition having the general formula: NaₐMn_{b}Fe_{c}Ti_{d}MₑO₂, wherein: M comprises one or more elements selected from the group consisting of aluminium, magnesium, zinc, copper, silicon, and zirconium; and wherein: 0.5<a≤1; 0.1≤b≤0.7; 0.1≤c≤0.7; 0<d≤0.3; and 0<e≤0.5, and wherein the composition is a layered sodium metal oxide material having at least a first phase and a second phase, wherein each phase is different and independently comprises one or more P2-type structures, one or more O3-type structures or one or more P3-type structures. Also described are methods of synthesizing layered sodium metal oxide materials as well as electrodes and energy storage devices including such compositions.

### TECHNICAL FIELD

The present invention relates to a metal oxide composition, in particular a layered sodium metal oxide material, which may find utility in sodium-ion batteries. The present invention also relates to a method of forming a layered sodium metal oxide material via a sol-gel route. The present invention also relates to a method of forming a layered sodium metal oxide material via a solid state route. The present invention also relates to an electrode comprising the layered sodium metal oxide material described herein as well as an energy storage device comprising the layered sodium metal oxide material as described herein, which may be a sodium-ion battery.

### BACKGROUND

Sodium-ion batteries (SIBs) show great promise as a low cost, sustainable and safe complement to Li-ion batteries (LIBs) for energy storage applications such as grid storage, data centres, and low speed electric vehicles. Li-ion batteries have shown great utility in high energy density applications such as portable electronics and electric cars, but suffer from multiple disadvantages related to safety and cost of the raw materials. For example, Li-ion batteries must be transported in a partially charged state, due to concerns over the dissolution of the Cu current collector at 0 V, which adds significant costs and safety issues. In contrast, Na-ion batteries use Al current collectors which do not react with Na even at 0 V, allowing them to be transported in the fully discharged state and thus removing safety concerns. Additionally, while LIBs have had several high profile issues related to the flammability of the electrolytes, SIB liquid electrolytes have been reported to be essentially non-flammable under testing, further enhancing the safety profile of SIBs.

In addition, the rapid growth of LIBs over the coming years is likely to result in supply issues of key elements such as Li, Ni, Cu and Co, which are not homogenously distributed within the Earth's crust and have already shown significant price volatility in recent years. Furthermore, elements such as Ni and Co are toxic, and Co has significant ethical issues associated with the use of child labour in the extraction process. Therefore, it is crucial to develop alternative energy storage technologies which are free of these elements to provide solutions which are truly sustainable, low cost, and non-toxic. Sodium-ion batteries based on Mn and Fe offer significant promise in this area, but suffer from performance issues such as low voltage, Jahn-Teller distortion, metal dissolution for Mn, and capacity fade due to Fe migration for Fe-based materials. Therefore, there is an urgent need to develop materials which can provide high energy density using a Fe³⁺/Fe⁴⁺ redox couple combined with good structural stability using Mn⁴⁺ and other low cost dopants, which would provide long cycling lifetimes.

Layered sodium metal oxides (NaₓMO₂) offer significant advantages over other positive electrode materials such as high capacity, high voltage and high tap densities, all of which make them ideal for high energy density batteries. Additionally, the high voltage Fe³⁺/Fe⁴⁺ redox couple has been shown to be active in these systems, unlike the LIB counterparts. Nevertheless, due to issues with long-term cycling stability of the Fe³⁺/Fe⁴⁺ redox couple, the highest performing materials to date are based on expensive and toxic Ni as the main redox-active transition metal. Replacing Ni with Fe is therefore the focus of a significant body of research.

Layered sodium metal oxides crystallise into two common phase structures, O3 and P2 (as shown in FIGS. 1a-b), classified using the nomenclature of Delmas et al (DOI: 10.1016/0378-4363 (80) 90214-4). All layered sodium metal oxides consist of alternating Na layers and transition metal layers, each separated by oxygen layers. O-type phases contain Na in octahedral sites, while P-type Na resides in prismatic sites. The numbers in the labels correspond to the number of layers required to complete a unit cell. Therefore, P2-type materials contain Na in prismatic sites, and contain 2 repeat layers in a unit cell, as a result of the ABBA-type stacking of the oxygen atoms. O3 phases have Na in octahedral sites, and require 3 repeat layers to form the unit cell, due to the ABCABC oxygen arrangement. Typically, O3 materials show higher initial charge capacities due to higher Na contents (typically 0.8-1 occupancy), while P2 materials show superior rate capabilities and cycling stabilities. However, the low Na contents of P2-type materials (typically around 0.67) hinder the use of this class of material in full cells against non-sodiated negative electrodes (such as commonly used hard carbons), where the positive electrode is the only Na source, resulting in low energy densities. Therefore, it is necessary to develop materials which can provide the high energy densities of the O3-type oxides and the good rate capability and cycling stabilites of the P2-type materials. One strategy that has been investigated to achieve this is by designing P2 materials with high Na contents (e.g. >0.8), but these materials typically utilise Li and Ni, which raises concerns over raw material supply and cost. An alternative strategy, which was first reported by Lee et al in 2014 (DOI: 10.1002/aenm.201400458), is to use O3/P2 bi-phasic materials. In this system, the O3 part of the material should act as an Na-source, allowing for high capacities and therefore high energy densities to be achieved. The P2 part of the material should provide structural stability and fast Na-diffusion channels, allowing for long cycling lifetimes and fast charging times.

However, most published O3/P2 bi-phasic materials have suffered from either low Na contents, use of expensive or unsustainable elements such as Li and Ni, or both. For example, the first report of an O3/P2 bi-phasic material by Lee et al (2014), studied the series Na₁₋ₓLiₓNi_{0.5}Mn_{0.5}O₂ (where 0<x<0.3). They showed that O3/P2 formed with Li, triggering the formation of the O3 phase by occupying the alkali metal layer, while the P2 part of the material consisted of Na in the alkali metal layer. Whilst these materials proved the existence of intergrown O3/P2 materials, the capacities were low, with initial charge capacities around 120 mAh g⁻¹, and significant fade was seen even after only 20 cycles. In addition, the use of Li and Ni is not ideal due to supply concerns.

Similarly, in 2015, Guo et al (DOI: 10.1002/anie.201411788) reported on the O3/P2 hybrid material Na_{0.66}Li_{0.18}Mn_{0.71}Ni_{0.21}Co_{0.08}O_{2+δ}, which has low Na content, leading to low initial charge capacities, and contains Li, Ni and Co. Li et al (DOI: 10.1021/acs.jpcc.5b11983) have reported the P2/O3 mixed phase series Na_{0.67}Mn_{0.55}Ni_{0.25}Ti_{0.2-x}LiₓO₂ (x=0, 0.1, 0.2), which suffers from low Na content, limiting the initial charge capacities to below 100 mAh g⁻¹, and the use of expensive Li and Ni.

In 2017, Bianchini et al (DOI: 10.1039/c7ta11180k) reported the P2/O3 material Na_{2/3}Li_{0.18}Mn_{0.8}Fe_{0.2}O₂, which uses only Li as a non-low cost element, but suffers from low Na content, giving low initial charge capacities of around 80 mAh g⁻¹. In addition, the material also suffers from poor cycling stability, retaining around 69% after 100 cycles. In 2020, Yang et al (DOI: 10.1002/adfm.202003364) reported the O3-rich (60% O3) O3/P2 mixed phase material Na_{0.8}Li_{0.2}Fe_{0.2}Mn_{0.6}O₂, which had a higher Na content, giving high capacities of up to 174 mAh g⁻¹ when charged to 4.5 V, and good cycling stability of 82% retention over 100 cycles. However, the polarisation from such a high charge cut-off was large (600 mV), and the use of Li is unlikely to be practical for commercial SIBs.

Qi et al (DOI: 10.1021/acsami.7b11282) have reported a high performing Ni-based O3/P2 material Na_{0.78}Ni_{0.2}Fe_{0.38}Mn_{0.42}O₂, which has high Na content and long cycling life, though capacities were limited to 85 mAh g⁻¹ in the potential window of 2.5-4.0 V. Finally, Zhou et al (DOI: 10.1016/j.jpowsour.2019.02.061) have reported on the only example found of a O3/P2 mixed phase material based only on Earth abundant elements, Na_{0.67}(Fe_{0.5}Mn_{0.5})₁₋ₓMgₓO₂ (x=0.05, 0.1, 0.15, 0.2, 0.25), where increasing the Mg content increased the O3 fraction formed in the material. In their most promising material, where x=0.15, initial discharge capacities were around 98 mAh g⁻¹, although the initial coulombic efficiency was over 100%, suggesting that the practical capacity in a full cell would be lower than this.

A. Tripathi et al, in Chem. Commun., 2020, 56, 10686-10689, describe an iron-containing P3 material with a high sodium content (Na_{0.9}Mn_{0.5}Fe_{0.5}O₂). This was synthesised via an intermediate with an O3/P3-type structure, which was then converted to a material with a pure P3-type structure. Properties of the O3/P3-type material are not described.

There is a need for a material that has a high Na content and is based exclusively on Earth abundant elements, avoiding the use of Li, Ni, Co and minimising Cu use, whilst maintaining high capacities and cycling stabilities.

### SUMMARY OF INVENTION

### Composition

The present invention provides materials with tuneable structures. The materials can be biphasic or triphasic. The materials can therefore have structures including combinations of two or more structures selected from O3, P2, and P3. While the O3 and P2 phases are the most commonly studied polymorphs of layered sodium metal oxides, the P3 phase is much less studied, despite potential advantages such as high voltage, large prismatic Na sites with direct Na diffusion pathways which should give good rate capability similar to the P2 structure, and, for Fe-based materials, potentially higher Na contents more similar to the O3 phase.

The materials of the present invention are based on elements which are in the top 10 most abundant on Earth. These materials have great promise for application in SIBs, with high energy density, long cycle lifetimes, and good rate capability. Furthermore, by providing a composition that allows a tunable O3:P2:P3 ratio (or a tunable multiphasic composition including two or more of P2, P3, and O3-type structures) with the same chemistry, the present invention allows for the fundamental relationship between the crystal structure and electrochemical performance to be exploited. Crucially, changing the ratio of the P2, P3, and O3-type structures allows for the tuning of performance parameters such as the voltage window, energy density, cycling stability and rate capability. This provides critical options for the production and use of low-cost positive electrode materials by allowing the same chemistry to be targeted at different applications (e.g. high energy or high power).

Therefore, in accordance with a first aspect of the invention, there is provided a composition having the general formula:

NaₐMn_{b}Fe_{c}Ti_{d}MₑO₂,

wherein M comprises one or more elements selected from the group consisting of aluminium, magnesium, zinc, copper, silicon and zirconium, wherein 0.5<a≤1; 0.1≤b ≤0.7; 0.1≤c≤0.7; 0<d≤0.3; and 0<e≤0.5, and wherein the composition is a layered sodium metal oxide material having at least a first phase and a second phase, wherein each phase is different and independently comprises one or more P2-type structures, one or more O3-type structures or one or more P3-type structures.

In some embodiments, a is at least 0.55, 0.6, 0.65 or 0.7. In some embodiments, a is no more than 0.95, 0.9, 0.85, 0.8 or 0.75. In some embodiments, 0.6≤a≤0.9, or 0.7≤a≤0.8, or 0.7≤a≤0.75, e.g. 0.7≤a≤0.9. For example, a may be 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89 or 0.90, such as 0.70, 0.71, 0.72, 0.73, 0.74, 0.75, 0.76, 0.77, 0.78, 0.79, or 0.80. Sometimes, a is 0.70 to 0.85.

In some embodiments, b is at least 0.15, 0.2, 0.25, 0.3 or 0.35. In some embodiments, b is no more than 0.65, 0.6, 0.55, 0.5 or 0.45. In some embodiments, 0.15≤b≤0.6, or 0.2≤b≤0.5, 0.25≤b≤0.5, 0.25≤b≤0.45, 0.3≤b≤0.5, or 0.3≤b≤0.45. For example, b may be 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, or 0.45. In other examples, b may be 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, or 0.5.

In some embodiments, c is at least 0.15, 0.2, 0.25, 0.3 or 0.35. In some embodiments, c is no more than 0.65, 0.6, 0.55, 0.5 or 0.45. In some embodiments, 0.15≤c≤0.6, 0.2≤c≤0.5, 0.2≤c≤0.45, or 0.25≤c≤0.45. For example, c may be 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, or 0.45. In other examples, c may be 0.2, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, or 0.45.

In some embodiments, d is at least 0.025, 0.05, 0.075, 0.1, 0.15, 0.2 or 0.25. In some embodiments, d is no more than 0.25, 0.2, 0.15, or 0.10. In some embodiments, 0.05≤d≤0.25, or 0.05≤d≤0.2, or 0.05≤d≤0.15. For example, d may be 0.05, 0.06, 0.07, 0.08, 0.09, 0.10, 0.11, 0.12, 0.13, 0.14, 0.15, 0.16, 0.17, 0.18, 0.19, or 0.20.

In some embodiments, e is at least 0.025, 0.05, 0.075, 0.1, 0.15, 0.2, 0.25, 0.3, 0.35 or 0.4, for example at least 0.025, 0.05, 0.075, or 0.1. In some embodiments, e is no more than 0.45, 0.4, 0.35, 0.3, 0.25, 0.2, or 0.15. In some embodiments, 0.05≤e≤0.4, or 0.05≤e≤0.3, 0.05≤e≤0.25, 0.05≤e≤0.22, or 0.05≤e≤0.2. For example, e may be 0.05, 0.06, 0.07, 0.08, 0.09, 0.10, 0.11, 0.12, 0.13, 0.14, 0.15, 0.16, 0.17, 0.18, 0.19, 0.20, 0.21, or 0.22. In other examples, e may be 0.05, 0.06, 0.07, 0.08, 0.09, 0.10, 0.11, 0.12, 0.13, 0.14, 0.15, 0.16, 0.17, 0.18, 0.19, or 0.20.

In some embodiments, b=c. For example, in some embodiments, b=0.4 and c=0.4, or b=0.35 and c=0.35. Alternatively, b may be greater or less than c. In some cases, b is equal to or greater than c, for example b may be greater than c by about a factor of 2. In some embodiments, d=e. For example, in some embodiments, d=0.1 and e=0.1, d=0.15 and e=0.15 or d=0.2 and e=0.2. In some embodiments, d=0.1 and e=0.1, or d=0.2 and e=0.2. Alternatively, d may be greater or less than e. In some cases, d is equal to or less than e. For example, in some embodiments, d=0.1 and e=0.2, d=0.05 and e=0.22, d=0.05 and e=0.2, d=0.1 and e=0.15, or d=0.05 and e=0.06.

As an example, in some embodiments, the composition may have the general formula:

Na_{0.7}Mn_{0.4}Fe_{0.4}Ti_{0.1}M_{0.1}O₂,

Na_{0.71}Mn_{0.4}Fe_{0.4}Ti_{0.1}M_{0.1}O₂,

Na_{0.72}Mn_{0.4}Fe_{0.4}Ti_{0.1}M_{0.1}O₂,

Na_{0.73}Mn_{0.4}Fe_{0.4}Ti_{0.1}M_{0.1}O₂,

Na_{0.74}Mn_{0.4}Fe_{0.4}Ti_{0.1}M_{0.1}O₂,

Na_{0.75}Mn_{0.4}Fe_{0.4}Ti_{0.1}M_{0.1}O₂,

Na_{0.76}Mn_{0.4}Fe_{0.4}Ti_{0.1}M_{0.1}O₂,

Na_{0.77}Mn_{0.4}Fe_{0.4}Ti_{0.1}M_{0.1}O₂,

Na_{0.78}Mn_{0.4}Fe_{0.4}Ti_{0.1}M_{0.1}O₂,

Na_{0.79}Mn_{0.4}Fe_{0.4}Ti_{0.1}M_{0.1}O₂,

Na_{0.80}Mn_{0.4}Fe_{0.4}Ti_{0.1}M_{0.1}O₂,

Na_{0.81}Mn_{0.4}Fe_{0.4}Ti_{0.1}M_{0.1}O₂,

Na_{0.82}Mn_{0.4}Fe_{0.4}Ti_{0.1}M_{0.1}O₂,

Na_{0.83}Mn_{0.4}Fe_{0.4}Ti_{0.1}M_{0.1}O₂,

Na_{0.84}Mn_{0.4}Fe_{0.4}Ti_{0.1}M_{0.1}O₂, or

Na_{0.85}Mn_{0.4}Fe_{0.4}Ti_{0.1}M_{0.1}O₂.

In some embodiments, the composition may have the general formula:

Na_{0.7}Mn_{0.4}Fe_{0.4}Ti_{0.1}M_{0.1}O₂,

Na_{0.71}Mn_{0.4}Fe_{0.4}Ti_{0.1}M_{0.1}O₂,

Na_{0.72}Mn_{0.4}Fe_{0.4}Ti_{0.1}M_{0.1}O₂,

Na_{0.73}Mn_{0.4}Fe_{0.4}Ti_{0.1}M_{0.1}O₂,

Na_{0.74}Mn_{0.4}Fe_{0.4}Ti_{0.1}M_{0.1}O₂,

Na_{0.75}Mn_{0.4}Fe_{0.4}Ti_{0.1}M_{0.1}O₂,

Na_{0.76}Mn_{0.4}Fe_{0.4}Ti_{0.1}M_{0.1}O₂,

Na_{0.77}Mn_{0.4}Fe_{0.4}Ti_{0.1}M_{0.1}O₂,

Na_{0.78}Mn_{0.4}Fe_{0.4}Ti_{0.1}M_{0.1}O₂,

Na_{0.79}Mn_{0.4}Fe_{0.4}Ti_{0.1}M_{0.1}O₂, or

Na_{0.80}Mn_{0.4}Fe_{0.4}Ti_{0.1}M_{0.1}O₂.

In some embodiments, the composition may have the general formula:

Na_{0.7}Mn_{0.35}Fe_{0.35}Ti_{0.1}M_{0.2}O₂,

Na_{0.71}Mn_{0.35}Fe_{0.35}Ti_{0.1}M_{0.2}O₂,

Na_{0.72}Mn_{0.35}Fe_{0.35}Ti_{0.1}M_{0.2}O₂,

Na_{0.73}Mn_{0.35}Fe_{0.35}Ti_{0.1}M_{0.2}O₂,

Na_{0.74}Mn_{0.35}Fe_{0.35}Ti_{0.1}M_{0.2}O₂,

Na_{0.75}Mn_{0.35}Fe_{0.35}Ti_{0.1}M_{0.2}O₂,

Na_{0.76}Mn_{0.35}Fe_{0.35}Ti_{0.1}M_{0.2}O₂,

Na_{0.77}Mn_{0.35}Fe_{0.35}Ti_{0.1}M_{0.2}O₂,

Na_{0.78}Mn_{0.35}Fe_{0.35}Ti_{0.1}M_{0.2}O₂,

Na_{0.79}Mn_{0.35}Fe_{0.35}Ti_{0.1}M_{0.2}O₂,

Na_{0.80}Mn_{0.35}Fe_{0.35}Ti_{0.1}M_{0.2}O₂,

Na_{0.81}Mn_{0.35}Fe_{0.35}Ti_{0.1}M_{0.2}O₂,

Na_{0.82}Mn_{0.35}Fe_{0.35}Ti_{0.1}M_{0.2}O₂,

Na_{0.83}Mn_{0.35}Fe_{0.35}Ti_{0.1}M_{0.2}O₂,

Na_{0.84}Mn_{0.35}Fe_{0.35}Ti_{0.1}M_{0.2}O₂, or

Na_{0.85}Mn_{0.35}Fe_{0.35}Ti_{0.1}M_{0.2}O₂.

In some embodiments, the composition may have the general formula:

Na_{0.7}Mn_{0.35}Fe_{0.35}Ti_{0.1}M_{0.2}O₂,

Na_{0.71}Mn_{0.35}Fe_{0.35}Ti_{0.1}M_{0.2}O₂,

Na_{0.72}Mn_{0.35}Fe_{0.35}Ti_{0.1}M_{0.2}O₂,

Na_{0.73}Mn_{0.35}Fe_{0.35}Ti_{0.1}M_{0.2}O₂,

Na_{0.74}Mn_{0.35}Fe_{0.35}Ti_{0.1}M_{0.2}O₂,

Na_{0.75}Mn_{0.35}Fe_{0.35}Ti_{0.1}M_{0.2}O₂,

Na_{0.76}Mn_{0.35}Fe_{0.35}Ti_{0.1}M_{0.2}O₂,

Na_{0.77}Mn_{0.35}Fe_{0.35}Ti_{0.1}M_{0.2}O₂,

Na_{0.78}Mn_{0.35}Fe_{0.35}Ti_{0.1}M_{0.2}O₂,

Na_{0.79}Mn_{0.35}Fe_{0.35}Ti_{0.1}M_{0.2}O₂,

Na_{0.80}Mn_{0.35}Fe_{0.35}Ti_{0.1}M_{0.2}O₂.

In some embodiments, the composition may have the general formula:

Na_{0.7}Mn_{0.4}Fe_{0.3}Ti_{0.15}M_{0.15}O₂,

Na_{0.71}Mn_{0.4}Fe_{0.3}Ti_{0.15}M_{0.15}O₂,

Na_{0.72}Mn_{0.4}Fe_{0.3}Ti_{0.15}M_{0.15}O₂,

Na_{0.73}Mn_{0.4}Fe_{0.3}Ti_{0.15}M_{0.15}O₂,

Na_{0.74}Mn_{0.4}Fe_{0.3}Ti_{0.15}M_{0.15}O₂,

Na_{0.75}Mn_{0.4}Fe_{0.3}Ti_{0.15}M_{0.15}O₂,

Na_{0.76}Mn_{0.4}Fe_{0.3}Ti_{0.15}M_{0.15}O₂,

Na_{0.77}Mn_{0.4}Fe_{0.3}Ti_{0.15}M_{0.15}O₂,

Na_{0.78}Mn_{0.4}Fe_{0.3}Ti_{0.15}M_{0.15}O₂,

Na_{0.79}Mn_{0.4}Fe_{0.3}Ti_{0.15}M_{0.15}O₂,

Na_{0.80}Mn_{0.4}Fe_{0.3}Ti_{0.15}M_{0.15}O₂.

Na_{0.81}Mn_{0.4}Fe_{0.3}Ti_{0.15}M_{0.15}O₂,

Na_{0.82}Mn_{0.4}Fe_{0.3}Ti_{0.15}M_{0.15}O₂,

Na_{0.83}Mn_{0.4}Fe_{0.3}Ti_{0.15}M_{0.15}O₂,

Na_{0.84}Mn_{0.4}Fe_{0.3}Ti_{0.15}M_{0.15}O₂, or

Na_{0.85}Mn_{0.4}Fe_{0.3}Ti_{0.15}M_{0.15}O₂.

In yet further examples, the composition may have the formula:

Na_{0.72}Mn_{0.4}Fe_{0.4}Ti_{0.1}M_{0.1}O₂,

Na_{0.72}Mn_{0.35}Fe_{0.25}Ti_{0.2}Cu_{0.2}O₂,

Na_{0.72}Mn_{0.35}Fe_{0.30}Ti_{0.2}Cu_{0.15}O₂,

Na_{0.72}Mn_{0.45}Fe_{0.25}Ti_{0.1}Cu_{0.2}O₂,

Na_{0.72}Mn_{0.39}Fe_{0.40}Ti_{0.05}Cu_{0.16}O₂,

Na_{0.73}Mn_{0.50}Fe_{0.25}Ti_{0.1}Cu_{0.15}O₂,

Na_{0.73}Mn_{0.4}Fe_{0.4}Ti_{0.1}Al_{0.1}O₂,

Na_{0.74}Mn_{0.50}Fe_{0.25}Ti_{0.05}Al_{0.05}Cu_{0.15}O₂,

Na_{0.74}Mn_{0.45}Fe_{0.28}Ti_{0.05}Cu_{0.22}O₂,

Na_{0.75}Mn_{0.4}Fe_{0.4}Ti_{0.1}Al_{0.1}O₂,

Na_{0.75}Mn_{0.4}Fe_{0.4}Ti_{0.1}Al_{0.1}O₂,

Na_{0.75}Mn_{0.35}Fe_{0.35}Ti_{0.1}Al_{0.1}Cu_{0.1}O₂,

Na_{0.75}Mn_{0.4}Fe_{0.4}Ti_{0.1}Mg_{0.1}O₂,

Na_{0.75}Mn_{0.4}Fe_{0.4}Ti_{0.1}Zn_{0.1}O₂,

Na_{0.75}Mn_{0.4}Fe_{0.4}Ti_{0.1}Cu_{0.1}O₂,

Na_{0.75}Mn_{0.4}Fe_{0.4}Ti_{0.1}Si_{0.1}O₂,

Na_{0.75}Mn_{0.4}Fe_{0.4}Ti_{0.1}Zr_{0.1}O₂.

Na_{0.75}Mn_{0.35}Fe_{0.35}Ti_{0.1}Al_{0.1}Cu_{0.1}O₂,

Na_{0.75}Mn_{0.45}Fe_{0.28}Ti_{0.05}Al_{0.05}Cu_{0.17}O₂,

Na_{0.75}Mn_{0.50}Fe_{0.25}Ti_{0.10}Cu_{0.15}O₂,

Na_{0.80}Mn_{0.4}Fe_{0.3}Ti_{0.15}Cu_{0.15}O₂,

Na_{0.80}Mn_{0.30}Fe_{0.30}Ti_{0.20}Cu_{0.20}O₂,

Na_{0.77}Mn_{0.4}Fe_{0.4}Ti_{0.1}Cu_{0.1}O₂, or

Na_{0.85}Mn_{0.4}Fe_{0.4}Ti_{0.1}Cu_{0.1}O₂.

In some embodiments, M comprises any one or more elements selected from the group consisting of aluminium, copper, magnesium, and zirconium. For example, M may be aluminium and/or copper.

In some embodiments, M comprises aluminium. In some embodiments, M comprises aluminium and one or more elements selected from the group consisting of magnesium, zinc, copper, aluminium, silicon, and zirconium. In some embodiments, M comprises aluminium and copper.

In some embodiments, the composition has the general formula:

NaₐMn_{b}Fe_{c}Ti_{d}AlₘM′ₙO₂,

wherein M′ comprises one or more elements selected from the group consisting of magnesium, zinc, copper, silicon, and zirconium, and wherein 0<m≤0.2 and 0<n≤0.2.

In some embodiments, m is at least 0.025, 0.05, 0.075, 0.1 or 0.15, e.g. at least 0.025, 0.05, 0.075 or 0.1. In some embodiments, m is no more than 0.15, 0.1, 0.075 or 0.05, e.g. no more than 0.15 or 0.1. In some embodiments, 0.05≤m≤0.15. For example, m may be 0.05, 0.06, 0.07, 0.08, 0.09, 0.10, 0.11, 0.12, 0.13, 0.14 or 0.15.

In some embodiments, n is at least 0.025, 0.05, 0.075, 0.1 or 0.15, e.g. at least 0.025, 0.05, 0.075 or 0.1. In some embodiments, n is no more than 0.22, 0.2, 0.17, 0.15, 0.1, 0.75 or 0.05, e.g. no more than 0.15 or 0.1. In some embodiments, 0.05≤n≤0.22. For example, n may be 0.05, 0.06, 0.07, 0.08, 0.09, 0.10, 0.11, 0.12, 0.13, 0.14, 0.15, 0.16, 0.17, 0.18, 0.19, 0.2, 0.21, or 0.22. In other embodiments, 0.05≤n≤0.2. For example, n may be 0.05, 0.06, 0.07, 0.08, 0.09, 0.10, 0.11, 0.12, 0.13, 0.14, 0.15, 0.16, 0.17, 0.18, 0.19, or 0.2. In some other embodiments, 0.05≤n≤0.15. For example, n may be 0.05, 0.06, 0.07, 0.08, 0.09, 0.10, 0.11, 0.12, 0.13, 0.14 or 0.15.

In some embodiments, m=n. For example, m and n may both be 0.1, or m and n may both be 0.2. Alternatively, m may be greater than or less than n. For example, in some embodiments m is equal to or less than n. In some embodiments, m is less than n, for example m is 0.05 and n is 0.17, or m is 0.05 and m is 0.15. In some embodiments, m is 0.1 and n is 0.2, or in other embodiments m is 0.2 and n is 0.1.

As an example, in some embodiments, the composition may have the general formula:

NaₐMn_{b}Fe_{c}Ti_{d}Al_{0.05}M′_{0.15}O₂,

NaₐMn_{b}Fe_{c}Ti_{d}Al_{0.05}M′_{0.17}O₂,

NaₐMn_{b}Fe_{c}Ti_{d}Al_{0.1}M′_{0.1}O₂,

NaₐMn_{b}Fe_{c}Ti_{d}Al_{0.1}M′_{0.2}O₂,

NaₐMn_{b}Fe_{c}Ti_{d}Al_{0.2}M′_{0.2}O₂, or

NaₐMn_{b}Fe_{c}Ti_{d}Al_{0.1}M′_{0.2}O₂,

where a is 0.7, 0.71, 0.72, 0.73, 0.74, 0.75, 0.76, 0.77, 0.78, 0.79, or 0.80, b is 0.2, 0.25, 0.3, 0.35, 0.4, 0.45 or 0.5, c is 0.2, 0.25, 0.28, 0.3, 0.35 or 0.4, and d is 0.05, 0.1, 0.15 or 0.2.

As a further example, in some embodiments, the composition may have the general formula:

NaₐMn_{b}Fe_{c}Ti_{d}Al_{0.1}M′_{0.1}O₂,

NaₐMn_{b}Fe_{c}Ti_{d}Al_{0.1}M′_{0.2}O₂,

NaₐMn_{b}Fe_{c}Ti_{d}Al_{0.2}M′_{0.2}O₂, or

NaₐMn_{b}Fe_{c}Ti_{d}Al_{0.1}M′_{0.2}O₂,

where a is 0.7, 0.71, 0.72, 0.73, 0.74, 0.75, 0.76, 0.77, 0.78, 0.79, or 0.80, b is 0.2, 0.25, 0.3, 0.35, or 0.4, c is 0.2, 0.25, 0.3, 0.35 or 0.4, and d is 0.05, 0.1, 0.15 or 0.2.

As described above, the composition is a layered sodium metal oxide material having at least a first phase and a second phase, wherein each phase is different and independently comprises one or more P2-type structures, one or more O3-type structures, or one or more P3-type structures. The phases of the composition may be represented by the general formula P2ₓO3_{y}P3_{z}, wherein each of x, y and z is 0 to 1, and at least two of x, y, and z are greater than 0.

In some embodiments, the first phase comprises one or more P2-type structures and the second phase comprises one or more O3-type structures. In other embodiments, the first phase comprises one or more P2-type structures and the second phase comprises one or more P3-type structures. Alternatively, the first phase comprises one or more P3-type structures and the second phase comprises one or more O3-type structures.

For the avoidance of doubt, the composition may comprise further phases in addition to the first and second phases. For example, the composition may comprise a third phase, which is different to the first and second phases and comprises one or more P2-type structures, one or more O3-type structures or one or more P3-type structures. In some embodiments, the composition has at least a first phase comprising one or more P2-type structures, a second phase comprising one or more O3-type structures, and a third phase comprising one or more P3-type structures.

In some embodiments, the composition consists of a first phase comprising one or more P2-type structures and a second phase comprising one or more O3-type structures. In other embodiments, the composition consists of a first phase comprising one or more P3-type structures and a second phase comprising one or more O3-type structures. Alternatively, the composition consists of a first phase comprising one or more P2-type structures, a second phase comprising one or more O3-type structures and a third phase comprising one or more P3-type structures. In other embodiments, the composition consists of a first phase comprising one or more P2-type structures and a second phase comprising one or more P3-type structures.

The layered sodium metal oxide material may comprise specific quantities of the first, second and/or third phase. For the avoidance of doubt, where quantities herein are expressed as percentages, the percentages refer to the wt %, as calculated by the Rietveld refinement method (Rietveld, H. M., J. Appl. Crystallogr. 1969, 2, 65-71). This method is well known in the art.

In some embodiments, the layered sodium metal oxide material may comprise from 0.1 to 99.1% of the first phase and from 99.1 to 0.1% of the second phase. Alternatively, the material may comprise from 5 to 95% of the first phase and from 95 to 5% of the second phase, from 10 to 90% of the first phase and from 90 to 10% of the second phase, from 20 to 80% of the first phase and from 80 to 20% of the second phase, or from 25 to 75% of the first phase and from 75 to 25% of the second phase. For example, where the layered sodium metal oxide material has a first phase comprising one or more P2-type structures and a second phase comprising one or more O3-type structures, the material may comprise from 12 to 92% of the first phase and from 88 to 8% of the second phase.

In some embodiments, the composition is a layered sodium metal oxide material having at least a first phase and a second phase, wherein the first phase comprises one or more P2-type structures and the second phase comprises one or more O3-type structures. In such embodiments, the layered sodium metal oxide material may comprise from 0.1 to 99.1% of the first phase (i.e. the P2 phase) and from 0.1 to 99.1% of the second phase (i.e. the O3 phase). Therefore, the layered sodium metal oxide material of the present invention may be P2/O3 bi-phasic (i.e. with a higher proportion of P2 phase than O3 phase) or O3/P2 bi-phasic (i.e. with a higher proportion of O3 phase than P2 phase).

The exact stoichiometry of the composition may be at least partly determined by the proportion of first phase and second phase. For example, in embodiments where the layered sodium metal oxide material is P2/O3 (i.e. comprising a higher proportion of the first phase compared with the second phase), the composition may have a general formula of Na_{0.73}Mn_{0.4}Fe_{0.4}Ti_{0.1}M_{0.1}O₂. In embodiments where the layered sodium metal oxide material is O3/P2 (i.e. comprising a higher proportion of the second phase compared with the first phase), the composition may have a general formula of Na_{0.75}Mn_{0.4}Fe_{0.4}Ti_{0.1}M_{0.1}O₂.

In accordance with a second aspect of the invention, there is provided an electrode comprising the layered sodium metal oxide material as described above in accordance with the first aspect.

In accordance with a third aspect of the invention, there is provided an energy storage device comprising the layered sodium metal oxide material as described above in accordance with the first aspect or the electrode as described above in accordance with the second aspect. In some embodiments, the energy storage device is a sodium-ion battery.

### Method of Synthesising a Layered Sodium Metal Oxide Material

In accordance with a fourth aspect of the invention, there is provided a method of forming the layered sodium metal oxide material described in accordance with the first aspect via a sol-gel route. The method comprises the following steps:
(a) providing a metal salt solution, the metal salt including salts of Na, Mn, Fe, and M;
(b) mixing a Ti-source, optionally TiO₂, with the metal salt solution;
(c) mixing a gelator with the metal salt solution to form a sol-gel solution;
(d) increasing the pH of the sol-gel solution;
(e) heating the sol-gel solution to form a gel; and
(f) subjecting the gel to calcination to obtain the layered sodium metal oxide material;
   wherein M comprises one or more elements selected from the group consisting of aluminium, magnesium, zinc, copper, silicon, and zirconium.

In some embodiments, a stoichiometric quantity of each metal salt is used. In some embodiments, an excess of the Na salt is used. In some embodiments, the metal salts are nitrates. The sodium salt may be provided in excess. The excess may be from around 1 wt % to around 10 wt %. The excess may be 1 wt %, 2 wt %, 3 wt %, 4 wt %, 5 wt %, 6 wt %, 7 wt %, 8 wt %, 9 wt %, or 10 wt %.

The method may include cooling the layered sodium metal oxide material.

In some embodiments, the stoichiometric ratio of TiO₂ to Mn, Fe, and M metal salts is calculated as the ratio of titanium to the metal salts, i.e. d:b+c+e, wherein b, c, d, and e are as described in respect of the first aspect of the present invention. As such, in such embodiments, the ratio could be 0.1, i.e. 1:9.

The gelator may be any molecule suitable for chelating with the metal salts to form a gel-like substance, e.g. a chelating agent. In some embodiments, the gelator comprises a carboxylic acid. For example, the carboxylic acid may comprise one or more acids selected from the group consisting of: citric acid, ethylenediaminetetraacetic acid (EDTA), tartaric acid, glycolic acid, and oxalic acid. In some embodiments, the gelator comprises one or more monosaccharides, such as glucose. In some embodiments, the gelator comprises one or more amino acids, such as glutamine or histidine. In a preferred embodiment, the gelator comprises citric acid.

In some embodiments, the stoichiometric ratio of gelator to metal salts is 1:1. In some embodiments, the gelator is added to the metal salt solution in the form of an aqueous solution. In some embodiments, the metal salt solution is allowed to homogenise before adding the gelator. In some embodiments, the sol-gel solution is allowed to homogenise after adding the gelator. Homogenisation may be achieved by stirring for a suitable amount of time, e.g. from several minutes up to several hours.

In some embodiments, step (d) of the method includes increasing the pH of the sol-gel solution to a pH of 6 to 10, preferably 7.5 to 8.5. In some embodiments, the pH of the sol-gel solution is increased to a pH of 8. The increase in pH may be achieved by addition of any suitable base to the sol-gel solution. In some embodiments, ammonia or an ammonium salt solution may be used to increase the pH of the sol-gel solution. In some embodiments, an ammonium nitrate solution is added to the sol-gel solution to increase the pH.

In some embodiments, step (e) includes heating the sol-gel solution to a temperature from 60 to 100° C. to form a gel. In some embodiments, the sol-gel solution is heated at a temperature of at least 60, 65, 70, 75, 80, 85, 90 or 95° C. to form a gel. In some embodiments, the sol-gel solution is heated at a temperature of no more than 100, 95, 90, 85, 80, 75, 70 or 65° C. to form a gel. In some embodiments, the sol-gel solution is heated at a temperature of from 65 to 95° C., from 70 to 90° C. or from 75 to 85° C. to form a gel. In some embodiments, the sol-gel solution is heated at a temperature of 80° C. to form a gel.

In some embodiments, step (e) includes heating the sol-gel solution for 2 to 24 hours to form a gel. In some embodiments, the sol-gel solution is heated for at least 2, 4, 6, 8, 10, 12, 14, 16, 18, 20, or 22 hours to form a gel. In some embodiments, the sol-gel solution is heated for no more than 22, 20, 18, 16, 14, 12, 10, 8, 6, or 4 hours to form a gel. In some embodiments, the sol-gel solution is heated for 2 to 18 hours, for 2 to 12 hours, or for 2 to 6 hours to form a gel.

In some embodiments, the gel is dried before being subjected to calcination. In some embodiments, the gel is ground to a powder before being subjected to calcination.

In some embodiments, step (f) includes subjecting the gel to calcination in an oxidising atmosphere. For example, the oxidising atmosphere may be air or oxygen.

In some embodiments, the step of calcining the gel may be performed at two different temperatures. For example, in some embodiments step (f) includes:
(g) calcining the gel at a first temperature of 400 to 600° C., then
(h) calcining the gel at a second temperature of 600 to 1200° C.

In some embodiments, the first temperature is at least 425, 450, 475 or 500° C. In some embodiments, the first temperature is no more than 575, 550, 525 or 500° C. In some embodiments, the first temperature is from 450 to 550° C. In some embodiments, the first temperature is 500° C.

In some embodiments, the second temperature is at least 650, 700, 750, 800, 850 or 900° C. In some embodiments, the second temperature is no more than 1150, 1100, 1050, 1000, 950, or 900° C., e.g. no more than 1150, 1100, 1050 or 1000° C. In some embodiments, the second temperature is from 700 to 1100° C., from 800 to 1100° C., from 850 to 1100° C., from 800 to 1000° C., from 850 to 1050° C., from 850 to 950° C. or from 900 to 1000° C. In some embodiments, the second temperature is 900° C. In other embodiments, the second temperature is 1000° C. It will be understood that the exact temperature used will depend on the ratio of P2:O3:P3 that the layered sodium metal oxide material should comprise. For example, higher ratios of O3 phase may require lower temperatures than the temperatures used for higher ratios of P2 and/or P3 phases. Higher ratios of P3 phase may require higher temperatures than the temperatures used for higher ratios of P2 phases. For example to increase the ratio of P3 phase, a second temperature of about 1000° C. may be used, to increase the ratio of P2 phase, a second temperature of about 900° C. may be used and to increase the ratio of O3 phase, a second temperature of about 800° C. may be used.

In some embodiments, step (g) includes calcining the gel at the first temperature for 2 to 6 hours and step (h) includes calcining the gel at the second temperature for 0.5 to 20 hours. In some embodiments, step (g) includes calcining the gel for at least 2, 3, 4 or 5 hours. In some embodiments, step (g) includes calcining the gel for no more than 6, 5, 4 or 3 hours. In some embodiments, step (g) includes calcining the gel for at least 0.5, 1 2, 3, 4, 5, 6, 8, 10, 12, 15, or 18 hours. In some embodiments, step (g) includes calcining the gel for no more than 20, 18, 15, 12, 10, 8, 6, 5, 4, 3, or 2 hours. It will be understood that the exact duration of the calcination will depend on the ratio of P2:O3:P3 that the layered sodium metal oxide material should comprise. For example, higher ratios of O3 phase may require shorter calcination times than higher ratios of P2 phase. Higher ratios of P3 phase may require shorter calcination times than higher ratios of O3 phase.

In some embodiments, for example where the layered sodium metal oxide material comprises one or more one or more P3-type structures, the step of calcining the gel includes three sub-steps. For example, in some embodiments step (f) includes:
(g) calcining the gel at a first temperature of 400 to 600° C., then
(h) calcining the gel at a second temperature of 600 to 1200° C., and then
(i) calcining the gel at a third temperature of 400 to 600° C.

Formation of the P3-type phase may be favoured at higher calcination temperatures (e.g. 900 to 1100° C.) and shorter calcination times (such as 2 to 6 hours). Formation of the P2-type phase may be favoured at higher calcination temperatures (e.g. 800 to 1000° C.) and longer calcination times (such as 6 to 12 hours). Formation of the O3-type phase may be favoured at lower calcination temperatures (e.g. 700 to 900° C.) and shorter calcination times (such as 0.25 to 4 hours).

Where a material contains a P2 and/or P3-type phase and an O3-type phase (e.g. P2P3O3, P2O3 or O3P3), a third calcination step at a temperature of 400 to 600° C., such as 500° C., and a calcination time of 2 to 6 hours may be used to convert the O3-type phase to a P3-type phase. For example, initially triphasic P2P3O3 materials may be converted by the third calcination step to biphasic P2P3 materials, and initially biphasic P2O3 may be converted by the third calcination step to triphasic P2P3O3 materials and/or biphasic P2P3 materials. Alternatively, the third calcination step may be used to increase the ratio of the P3-type phase in P2P3O3 or O3P3 materials. Accordingly, the third calcination step allows further tuning of the phase ratios and compositions.

In some embodiments, the step of calcining the gel is performed using a heating rate of 5° C./min.

In some embodiments, the layered sodium metal oxide material may be ground into a powder after cooling. In some embodiments, the layered sodium metal oxide material may be ground into a powder after cooling to 250° C. to 300° C. In some embodiments, the layered sodium metal oxide material may be ground under an inert atmosphere, e.g. argon or nitrogen.

According to a fifth aspect of the present invention, there is provided a method of forming the layered sodium metal oxide material described in accordance with the first aspect via a solid-state route. The method comprises the following steps:
a) providing a sodium source, optionally sodium carbonate,
b) providing Mn₃O₄, Fe₂O₃, TiO₂.
c) providing an M oxide, wherein M comprises one or more elements selected from the group consisting of aluminium, magnesium, zinc, copper, silicon, and zirconium;
d) milling the compounds of steps a), b), and c) together;
e) pelletising the mixture from step d);
f) calcining the pelletised mixture from step e).

For the avoidance of doubt, step e) (pelletising the mixture from step d) is an optional step and need not be carried out (see, for example L. Yang et al., Adv. Funct. Mater., 2020, 30, 2003364, where pelletisation was not carried out before calcination). Where step e) is not carried out, step f) may comprise calcining the mixture from step d). It is known in the art that pellets need not be formed prior to calcining electrode materials, thus step e) would be considered non-essential by the skilled person.

The sodium source, optionally sodium carbonate, may be provided in excess. The excess may be from around 1 wt % to around 10 wt %. The excess may be 1 wt %, 2 wt %, 3 wt %, 4 wt %, 5 wt %, 6 wt %, 7 wt %, 8 wt %, 9 wt %, or 10 wt %.

The compounds of steps a) to c) are preferably provided in amounts corresponding to the general formula of the first aspect of the present invention. That is to say, the compounds are provided in amounts such that the final composition has the formula according to the first aspect of the present invention.

The compounds may be milled in a ball mill. The compounds may be milled for a sufficient time to homogenise the mixture. For example, the compounds may be milled for between from around 1 hour up to around 4 hours. The compounds may be milled at any suitable speed. For example, the compounds may be milled at from around 200 rpm to around 600 rpm, optionally at around 400 rpm.

The mixture may be calcined in air. The mixture may be calcined at any suitable temperature, for example from around 600° C. to around 1200° C., optionally at around 900° C. The heating/cooling rate may be selected as appropriate and may be, for example 5° C./min.

After calcining, the calcined mixture may be allowed to cool to around 250-300° C. before being transferred to an argon-filled glovebox.

According to a further aspect of the invention, there is provided a layered sodium metal oxide material produced by the method of the fourth or fifth aspects.

It will be appreciated that features of any one of the aspects of the present invention may be combined with features of any of the other aspects of the present invention except where there is technical incompatibility. All such combinations are explicitly considered and disclosed herein.

The invention may be further understood with reference to the following non-limiting clauses:

1. A composition having the general formula:

NaₐMn_{b}Fe_{c}Ti_{d}MₑO₂,

wherein:
M comprises one or more elements selected from the group consisting of aluminium, magnesium, zinc, copper, silicon, and zirconium; and
   wherein:
0.5<a≤1;
0.1≤b≤0.7;
0.1≤c≤0.7;
0<d≤0.3; and
0<e≤0.5.
   2. The composition of clause 1, wherein:
0.6≤a≤0.9; and/or
0.2≤b≤0.5; and/or
0.2≤c≤0.5; and/or
b=c; and/or
d=e.
   3. The composition of clause 1 or clause 2, wherein M comprises aluminium, optionally wherein M comprises aluminium and one or more elements selected from the group consisting of magnesium, zinc, copper, aluminium, silicon, and zirconium.
   4. The composition of any one of the preceding clauses, wherein M comprises aluminium and copper.
   5. The composition of any one of the preceding clauses, having the general formula:

NaₐMn_{b}Fe_{c}Ti_{d}AlₘM′ₙO₂,

wherein:
M′ comprises one or more elements selected from the group consisting of magnesium, zinc, copper, silicon, and zirconium; and wherein:
0<m≤0.2; and
0<n≤0.2.
   6. The composition of any one of the preceding clauses, wherein the composition is a layered sodium metal oxide material having at least a first phase, and wherein the first phase comprises one or more P2-type structures.
   7 The composition of clause 6, wherein the composition is a layered sodium metal oxide material having at least a first phase and a second phase, and wherein the first phase comprises one or more P2-type structures and the second phase comprises one or more O3-type structures.
   8. The composition of clause 7, wherein the layered sodium metal oxide material comprises from 0.5 to 100% of the first phase and from 0 to 99.5% of the second phase.
   9. An electrode comprising the layered sodium metal oxide material of any one of clauses 6 to 8.
   10. An energy storage device comprising the layered sodium metal oxide material of any one of clauses 6 to 8 or an electrode according to clause 9, optionally wherein the energy storage device is a sodium-ion battery.
   11. A method of forming a layered sodium metal oxide material via a sol-gel route, the method comprising:
(a) providing a metal salt solution, the metal salts including salts of Na, Mn, Fe, and M;
(b) mixing a Ti source, optionally TiO₂, with the metal salt solution;
(c) mixing a gelator with the metal salt solution to form a sol-gel solution;
(d) increasing the pH of the sol-gel solution;
(e) heating the sol-gel solution to form a gel; and
(f) subjecting the gel to calcination to obtain the layered sodium metal oxide material;
   wherein M comprises one or more elements selected from the group consisting of aluminium, magnesium, zinc, copper, aluminium, silicon, and zirconium.
   12. The method of clause 11, wherein the gelator is a carboxylic acid, optionally wherein the carboxylic acid is citric acid.
   13. The method of clause 11 or clause 12, wherein the stoichiometric ratio of gelator to metal salts is 1:1.
   14. The method of any one of clauses 11 to 13, wherein step (d) includes increasing the pH of the sol-gel solution to a pH of 6 to 10, optionally to a pH of 7.5 to 8.5.
   15. The method of any one of clauses 11 to 14, wherein step (e) includes heating the sol-gel solution at a temperature from 60 to 100° C., optionally wherein step (e) includes heating the sol-gel solution for 2 to 24 hours.
   16. The method of any one of clauses 11 to 15, wherein step (f) includes subjecting the gel to calcination in an oxidising atmosphere, optionally wherein the oxidising atmosphere is air.
   17. The method of any one of clauses 11 to 16, wherein step (f) includes:
(g) calcining the gel at a first temperature of 400 to 600° C., then
(h) calcining the gel at a second temperature of 600 to 1200° C.
   18. The method of clause 17, wherein step (g) includes calcining the gel at the first temperature for 2 to 6 hours and step (h) includes calcining the gel at the second temperature for 0.5 to 20 hours.
   19. A method of forming a layered sodium metal oxide material via a solid-state route. The method comprises the following steps:
a) providing a sodium source, optionally sodium carbonate,
b) providing Mn₃O₄, Fe₂O₃, TiO₂,
c) providing an M oxide, wherein M comprises one or more elements selected from the group consisting of aluminium, magnesium, zinc, copper, aluminium, silicon, and zirconium;
d) milling the compounds of steps a), b), and c) together;
e) pelletising the mixture from step d);
f) calcining the pelletised mixture from step e).
   20. The layered sodium metal oxide material produced by the method of any one of clauses 11 to 19.

### BRIEF DESCRIPTION OF THE DRAWINGS

FIG. 1 is a diagram of the crystal structures of P2-type, O3-type and P3-type layered sodium metal oxides.

FIGS. 2a-b are powder X-ray diffractograms showing the presence of O3 and/or P2 phases in each material.

FIGS. 3a-d show charge-discharge load curves for each material at 25 mA g⁻¹.

FIG. 4 shows discharge capacities for each material across 100 cycles at 25 mA g⁻¹.

FIG. 5 shows discharge capacities for each material at specific currents of 25, 50, 100, 250 and 500 mA g⁻¹.

FIGS. 6a-d show cyclic voltammograms for each of the materials measured for five cycles in a potential window of 2.5-4.2 V vs. Na⁺/Na at a scan rate of 0.030 mV s⁻¹.

FIGS. 7a-c are ex situ X-ray diffraction patterns collected in the pristine state, after charging to 4.0 V or 4.2 V, and after discharging to 2.5 V.

FIG. 8a shows a voltage profile for the P2 material cycled between 2.5-4.3 V.

FIG. 8b shows a voltage profile for the O3/P2 material cycled between 2.2-4.2 V.

FIG. 9a shows specific discharge capacities and electrode discharge energy densities for the P2 material cycled between 2.5-4.3 V.

FIG. 9b shows specific discharge capacities and electrode discharge energy densities for the O3/P2 material cycled between 2.2-4.2 V.

FIGS. 10a-b are powder X-ray diffractograms showing the presence of O3 and/or P2 phases in the series Na_{0.75}Mn_{0.4}Fe_{0.4}Ti_{0.1}M_{0.1}O₂.

FIG. 11 shows discharge capacities for materials in the series Na_{0.75}Mn_{0.4}Fe_{0.4}Ti_{0.1}M_{0.1}O₂.

FIG. 12 shows powder X-ray diffraction patterns for solid-state and sol-gel synthesised materials.

FIG. 13 shows a selected area electron diffraction (SAED) pattern for a single particle of Na_{0.75}Mn_{0.35}Fe_{0.35}Ti_{0.1}Al_{0.1}Cu_{0.1}O₂ material.

FIG. 14 shows charge-discharge load curves of the solid-state synthesised material cycled between 2.5-4.2 V at 25 mA g⁻¹.

FIG. 15 shows the discharge capacities of the solid-state and sol-gel synthesised materials cycled between 2.5-4.2 V at 25 mA g⁻¹.

FIG. 16 shows powder X-ray diffraction pattern confirming the P2/P3 nature of the bi-phasic material Na_{0.80}Mn_{0.4}Fe_{0.3}Ti_{0.15}Cu_{0.15}O₂.

FIG. 17 shows powder X-ray diffraction pattern confirming the O3/P2 and P2/O3 nature of the bi-phasic materials shown.

FIG. 18 shows the discharge capacities of the materials shown, cycled between 2.5-4.2 V at 25 mA g⁻¹.

FIG. 19 shows powder X-ray diffraction pattern confirming the O3/P2 nature of the bi-phasic materials shown.

FIG. 20 shows the discharge capacities of the materials shown, cycled between 2.5-4.2 V at 25 mA g⁻¹.

FIG. 21 shows powder X-ray diffraction pattern confirming the P2/O3 nature of the bi-phasic materials shown.

FIG. 22 shows the discharge capacities of the materials shown, cycled between 2.5-4.2 V at 25 mA g⁻¹.

FIG. 23 shows the discharge capacity of the P2/P3 Na_{0.80}Mn_{0.4}Fe_{0.3}Ti_{0.15}Cu_{0.15}O₂.

FIG. 24 shows powder X-ray diffraction pattern confirming the O3/P3 nature of the bi-phasic materials O3/P3-Na_{0.77}Mn_{0.4}Fe_{0.4}Ti_{0.1}Cu_{0.1}O₂ and P3/O3-Na_{0.85}Mn_{0.4}Fe_{0.4}Ti_{0.1}Cu_{0.1}O₂.

FIG. 25 shows the discharge capacity of O3P3-Na_{0.77}Mn_{0.4}Fe_{0.4}Ti_{0.1}Cu_{0.1}O₂ and P3O3-Na_{0.85}Mn_{0.4}Fe_{0.4}Ti_{0.1}Cu_{0.1}O₂ relative to P3 and O3 single-phase materials.

FIG. 26 shows powder X-ray diffraction pattern confirming the O3P3P2 nature of the tri-phasic material O3P3P2 Na_{0.85}Mn_{0.4}Fe_{0.3}Ti_{0.15}Cu_{0.15}O₂.

FIG. 27 shows the discharge capacity of the O3P3P2 Na_{0.85}Mn_{0.4}Fe_{0.3}Ti_{0.15}Cu_{0.15}O₂ material.

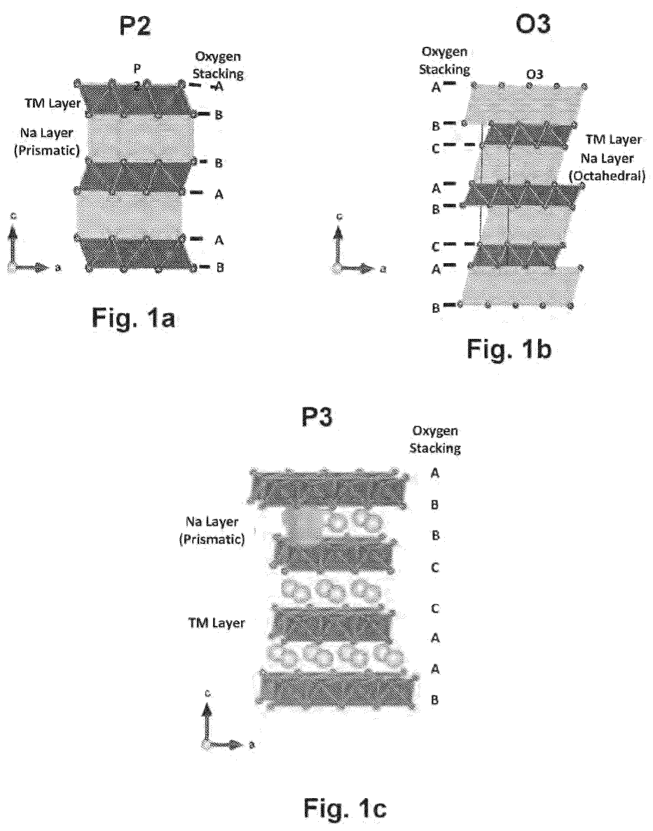

### EXAMPLE 1

### Synthesis of Layered Sodium Metal Oxide Material

Four materials based on the chemistry Na_{0.72}-0.75Mn_{0.4}Fe_{0.4}Ti_{0.1}Al_{0.1}O₂, with different O3:P2 mass ratios of 1:0, 0.71:0.29, 0.69:0.31 and 0:1 (calculated by Rietveld Refinement), were synthesised using a citric acid sol-gel method. The target composition of the materials is detailed in Table 1.

Stoichiometric amounts of sodium nitrate, manganese nitrate, iron nitrate and aluminum nitrate were dissolved in di-ionised (DI) water and stirred for 10 mins. A 2 wt % excess of sodium nitrate was used. A sodium content of 0.72 was targeted for the pure phase P2 material, 0.73 for the majority P2 phase P2/O3 material and 0.75 was targeted for the majority O3 phase O3/P2 and pure phase O3 materials. Stoichiometric TiO₂ nanopowder was then added to the solution under stirring, and left to homogenise under stirring for a further 10 mins. Citric acid was dissolved in a separate beaker (1:1 citric acid to metal ratio) and then added to the nitrate solution. After stirring for 2 hours, ammonium nitrate solution was added to adjust the pH from 1 to 8. The solution was then left to stir for a further 2 hours, before heating to 80° C. overnight for gel formation. The gel was then dried at 130° C. for 6 hours, before being ground in a pestle and mortar and calcined under air for 4 hours at 500° C., followed by 12 hours at 900° C. using a heating/cooling rate of 5° C./min. For the O3 material, the high temperature calcination was carried out at 800° C. for 1 hour. Once cooled to 250° C., the samples were removed and ground in a dry room before transferring to an argon-filled glovebox.

TABLE 1

| | | Phase |
|---|---|---|
| Sample | | composition |
| Name | Composition | (O3:P2 ratio) |
| P2 | Na_{0.72}Mn_{0.4}Fe_{0.4}Ti_{0.1}Al_{0.1}O₂ | 0:1 |
| P2/O3 | Na_{0.73}Mn_{0.4}Fe_{0.4}Ti_{0.1}Al_{0.1}O₂ | 0.69:0.31 |
| O3/P2 | Na_{0.75}Mn_{0.4}Fe_{0.4}Ti_{0.1}Al_{0.1}O₂ | 0.71:0.29 |
| O3 | Na_{0.75}Mn_{0.4}Fe_{0.4}Ti_{0.1}Al_{0.1}O₂ | 1:0 |

### Material Characterisation

Powder x-ray diffraction (XRD) patterns were obtained using a PANalytical Empyrean diffractometer in Bragg-Brentano geometry with Cu Kα₁ radiation (λ=1.5406 Å). Structures were refined by the Rietveld method using GSAS-II. Scanning electron microscopy (SEM) images of as-synthesised materials coupled with Energy Dispersive x-ray spectroscopy (EDS) were recorded on a JEOL JSM-6700F.

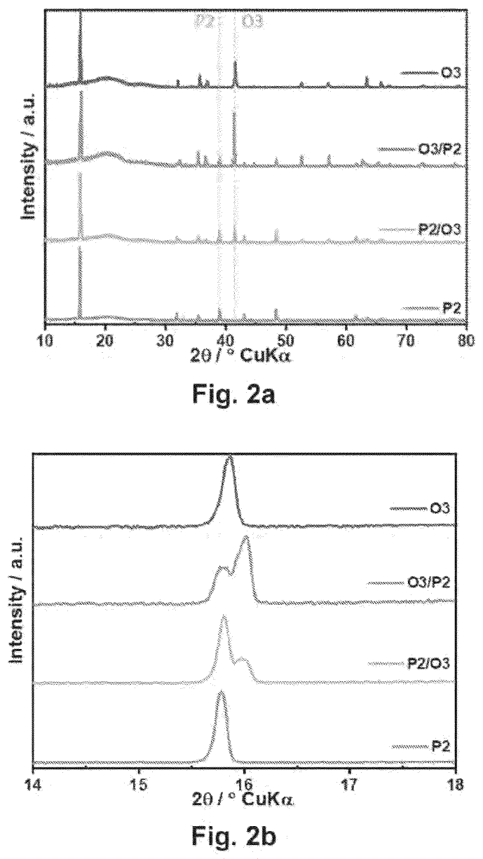

The results are shown in FIGS. 2a-b, where FIG. 2a shows the full range collected from 10-80 degrees 2θ, while FIG. 2b shows an expanded version of FIG. 2a focusing on the (001) peaks. In FIG. 2a, the left dashed line highlights a key peak for identifying the P2 phase, while the right dashed line highlights a key peak for identifying the O3 phase.

### Electrochemical Characterisation

To investigate the electrochemical performance of the materials, slurries were prepared using the active material synthesised by the method above, super C65 carbon and Solef 5130 binder (a modified polyvinylidene fluoride (PVDF)), in the mass ratio 80:10:10, in n-methyl-2-pyrrolidone (NMP). The slurry was cast onto aluminum foil using a doctor blade. After drying, 10 mm diameter electrode discs were punched and used to prepare CR2325 coin cells. All slurry processing, casting, drying, punching and coin cell assembly was carried out in an argon-filled glovebox (O₂<0.1 ppm, H₂O<0.1 ppm). Sodium metal was used as a counter/reference electrode, a glass fiber paper (Whatman, GF/F) was used as the separator and 1 M NaPF₆ in EC/DEC was used as the electrolyte. Galvanostatic charge/discharge cycling and cyclic voltammetry were carried out at 30° C. using a Biologic BCS-805 battery cycler.

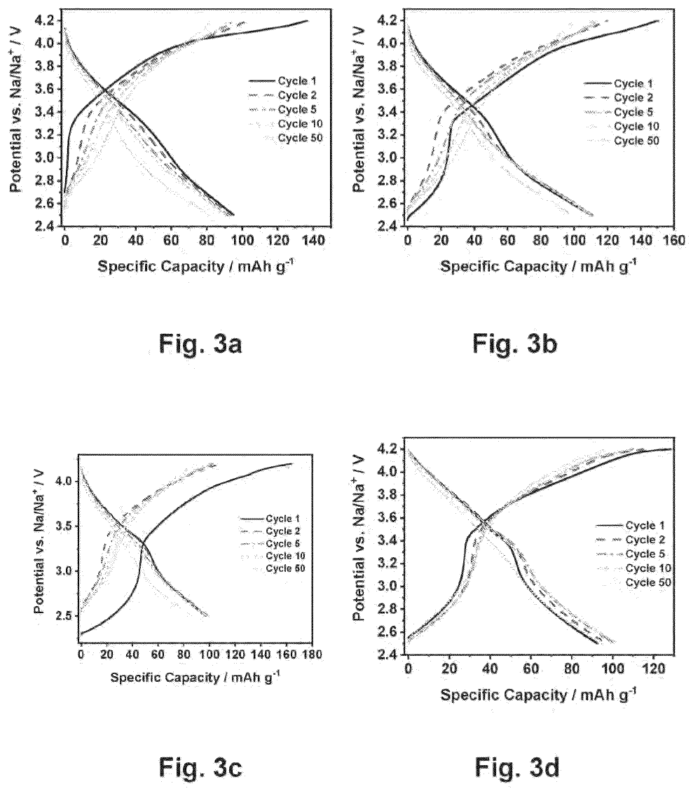

The resulting load curves are shown in FIGS. 3a-d. Two main regions can be observed, with a low voltage region corresponding to the Mn³⁺/Mn⁴⁺ redox couple, and a high voltage region (ca. >3.0 V) resulting from the Fe³⁺/Fe⁴⁺ redox couple. Although the shapes are broadly similar for all materials, the region relating to Mn redox appears to increase with increasing P2 content. For all materials, the load curves become more linear upon cycling, suggesting fewer phase changes occur in later cycles.

In each case, the initial charge capacity was significantly higher than the initial discharge capacity, confirming that the materials all contained sufficient Na for use in a full cell, and do not rely on additional Na from the metallic counter electrode to achieve high capacities in half cell format. The initial charge capacities were 137, 151, 164 and 128 mAh g⁻¹ for O3, O3/P2, P2/O3 and P2, respectively. The initial discharge capacities were higher for the bi-phasic materials compared to the pure phase materials, with the O3/P2 and P2/O3 materials having initial discharge capacities of 110 and 98 mAh g⁻¹, respectively, compared to 95 and 92 mAh g⁻¹ for the pure phase O3 and P2 materials, respectively. This suggests that the bi-phasic materials have higher initial electrochemical activity compared to the pure phase materials, and that the same result could not be achieved by simply physically combining the two pure phase materials.

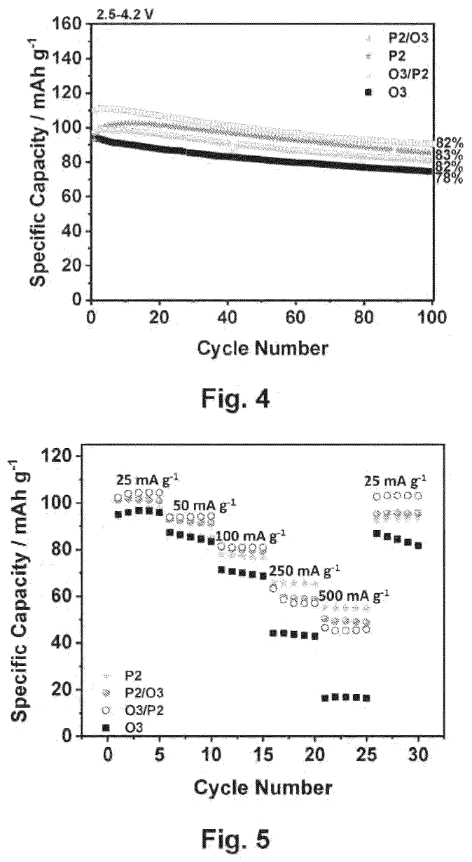

As shown in FIG. 4, over subsequent cycles the P2-containing materials underwent slight increases in their capacities, with the P2/O3 material increasing from 98 to 99 mAh g⁻¹ and the O3/P2 material increasing from 110 to 111 mAh g⁻¹. This effect was greatest in the pure phase P2 material, which saw an increase in capacity from 93 to 102 mAh g⁻¹ over the first 12 cycles, before beginning to gradually fade. In contrast, no activation was observed in the pure phase O3 material, which gradually faded throughout the entire range of cycling. After 100 cycles, the P2 material showed the highest cycling stability, with 83% of the maximum capacity retained. Both bi-phasic materials showed similar capacity fade, with 82% capacity retention after 100 cycles, while the pure phase O3 material showed the most fade, retaining 78% of its maximum capacity. This showed that even when P2 was the minor phase in the material, it had a significant effect in stabilising the cycling performance, which is likely due to reduced overall volume changing occurring in the bi-phasic materials, due to complementary lattice changes in the respective phases during cycling. The O3/P2 material, which consisted of 69% O3 phase, only has 1% greater capacity loss compared to the fully P2 phase.

As shown in FIG. 5, rate capability testing (carried out at 25, 50, 100, 200 and 500 mA g⁻¹) revealed that the high rate performance increased with increasing P2 content. The O3/P2 material showed significantly enhanced capacity at 500 mA g⁻¹ compared to the pure phase O3 material (45 mAh g⁻¹ compared to 17 mA g⁻¹, respectively), again demonstrating that including a small quantity of P2 phase in the material can significantly enhance performance. Overall, the pure phase P2 material showed the best rate capability with capacities of 94, 86, 77, 66 and 55 mAh g⁻¹ at 25, 50, 100, 200 and 500 mA g⁻¹ respectively, compared to 101, 92, 80, 59 and 49 mAh g⁻¹ for the P2/O3 material, 105, 94, 81, 57 and 45 mAh g⁻¹ for the O3/P2 material and 95, 86, 70, 44 and 17 mAh g⁻¹ for the pure phase O3 material. These results confirmed that at low rates, the bi-phasic materials have higher capacities than the pure phase materials, but as the rate increases the P2 content becomes the crucial factor in determining performance. This reveals that tuning the P2/O3 ratio can be used to design materials with different characteristics, such as using bi-phasic materials for high energy applications, or P2-rich materials for high power applications, without altering the underlying chemistry.

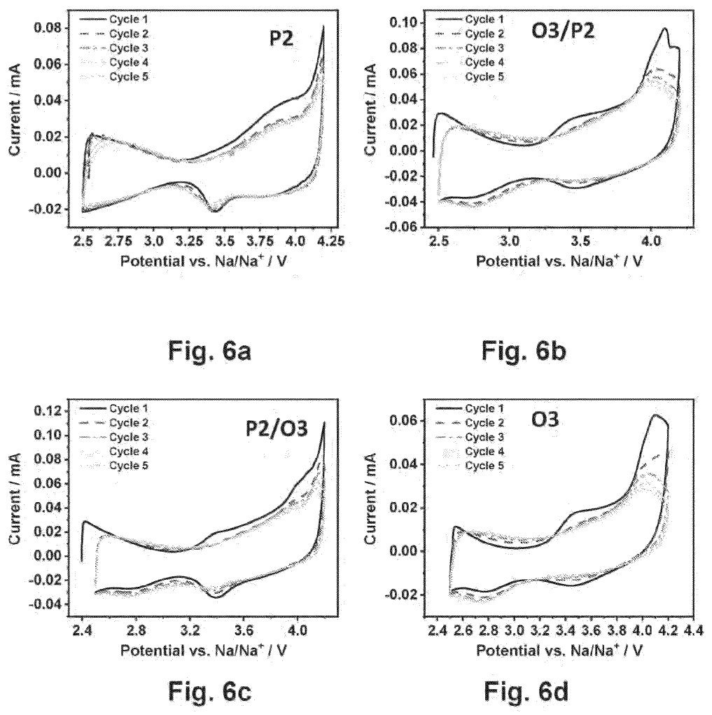

Cyclic voltammetry was carried out in the same potential window (2.5-4.2 V) using a scan rate of 0.030 mV s⁻¹, to gain insight into the electrochemical reactions occurring during cycling. The results are shown in FIGS. 6a-d.

It can be seen that all four materials have broadly similar shapes, with peaks around 2.6-2.7 V corresponding to the Mn³⁺/Mn⁴⁺ redox couple and 3.3-3.5 V corresponding to the Fe³⁺/Fe⁴⁺ redox couple, which matches well with the load curves shown in FIGS. 3a-d. However, in the high voltage region (above ˜3.9 V), key differences can be observed depending on the phase ratio present in the materials. For the pure phase P2 material, only a single sharp peak is present in this region, with an onset of around 4.1 V. Likewise, only a single peak is present in this region for the pure phase O3 material, but this peak is broader and has an onset of around 3.9 V. Both these peaks are visible in the bi-phasic materials, with the relative intensity proportional to the content of P2 and O3 present in the sample. For the P2/O3 material, the peak present in the P2 material with an onset of 4.1 V has much greater intensity than the peak present in the O3 material with an onset of 3.9 V, while the opposite is true for the O3/P2 material.

This shows that both the O3 and P2 phases are electrochemically active in the bi-phasic materials, and therefore contribute to Na storage in the proportion that they were synthesised in. This is in contrast to some previous reports on O3/P2 bi-phasic materials, where only the major phase was active (DOI: 10.1039/c7ta11180k). While there was some gradual fade of these high voltage peaks across the first five cycles, overall there were limited changes to the features present, consistent with stable cycling performance. In particular, cycles 4 and 5 almost entirely overlap for all four materials.

### Ex Situ Electrochemical Characterisation

To prepare materials for ex-situ characterisation, powder working electrodes were constructed by mixing the active material and super C65 carbon in the mass ratio 75:25 with no binder, using a swagelok-type cell. All other components were the same as used for the coin cells. The cells were charged to the desired state-of-charge, transferred to an argon-filled glovebox, disassembled, washed using dimethylcarbonate (DMC), and dried overnight under vacuum at room temperature. Glass capillaries were filled and sealed with vacuum grease, and X-ray diffraction patterns were collected in transmission mode (Debyey-Schrrer geometry) using Mo Kα radiation, λ=0.71 Å, on a PANalytical Empyrean diffractometer.

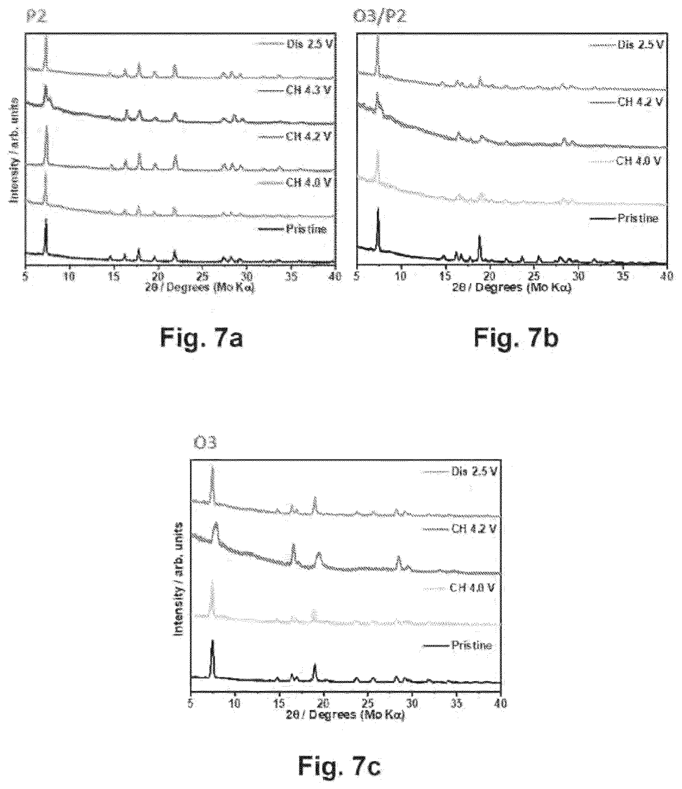

To investigate any changes in crystal structure during cycling, ex-situ XRD was carried out at selected states-of-charge for the P2, O3 and O3/P2 materials. The results are shown in FIGS. 7a-c.

Electrodes were extracted after charging to 4.0 V, 4.2 V and after discharging to 2.5 V, and compared to pristine materials. For the P2 material, no major changes in crystal structure could be seen at any state-of-charge, with the P2 structure being retained throughout the first cycle, showing that (de) sodiation occurs via a solid-solution pathway. Small shifts in the lattice parameters can be observed, with a slight expansion upon charging to 4.0 V, followed by a slight contraction after further charging to 4.2 V. After discharging (sodiation) to 2.5 V, the structure expands slightly, although it does not fully return to the original pristine state, showing that minor irreversible changes occur. This lack of the major phase change during the first cycle is consistent with the stable cycling performance shown by this material.

For the pure phase O3 material, no major structural change could be detected after charging to 4.0 V, although minor changes in the lattice parameters did occur. Upon further charging to 4.2 V, some significant changes could be seen. Specifically, all peaks broadened considerably, implying decrease in crystallinity and long-range order. As a result of this broadening, some peaks could no longer to be detected. Additionally, the (003) diffraction peak shifted from 7.4 to 7.9 degrees 2θ, consistent with a large contraction of the c-parameter and interlayer spacing. These changes were indexed to a new distorted O′3 phase, showing that the CV peak between 3.9-4.1 V results from a O3→O′3 transition. The large change in lattice parameters associated with the appearance of this new phase explains the poorer cycling stability observed in this material compared to the pure phase P2 material.

For the O3/P2 bi-phasic material, a small expansion of the c-parameter is observed upon charging to 4.0 V, with shifts of both the (002) and (003) diffraction peaks for the P2 and O3 phases, respectively. After further charging to 4.2 V, a loss of long-range order in the material was observed, with all remaining peaks broadening significantly and showing loss of intensity. Limited shift is seen for the P2 (002) diffraction peak, though there is a loss of intensity compared to what was seen for the pure phase P2 material at the same state-of-charge. For the O3 (003) diffraction peak, there is a shift to lower 20 values (contraction of the c-axis), as was observed for the formation of the O′3 phase for the pure phase O3 material, although the contraction in the c-parameter is slightly smaller than was seen for the pure phase O3 material. That major changes occur in the diffraction peaks for both the P2 and O3 phase demonstrate clearly that both phases are electrochemically active in the bi-phasic material, and both contribute to capacity, allowing high energy densities to be obtained. This is in contrast to some previous reports of O3/P2 composites, where the minor phase has been reported to be inactive, which limits the available energy density. After discharging to 2.5 V, the original O3/P2 diffraction pattern reforms, showing that the phase changes seen during charging are reversible, which explains the stable long-term cycling stability shown by this material.

### High Energy Density Testing

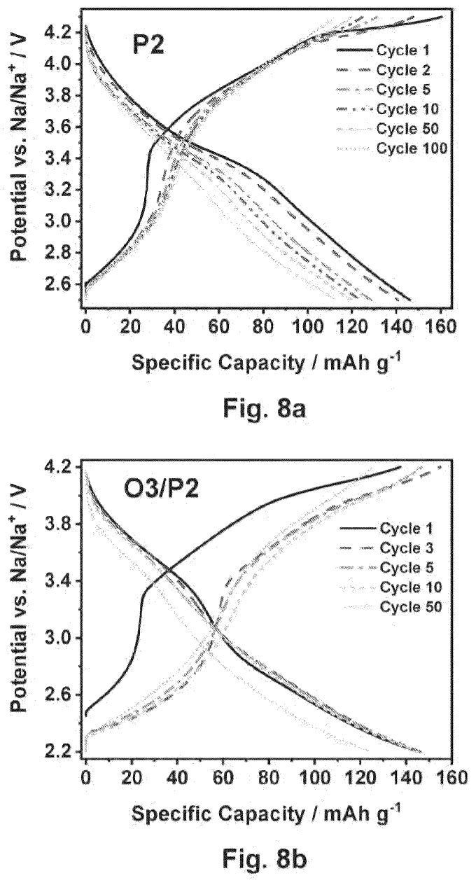

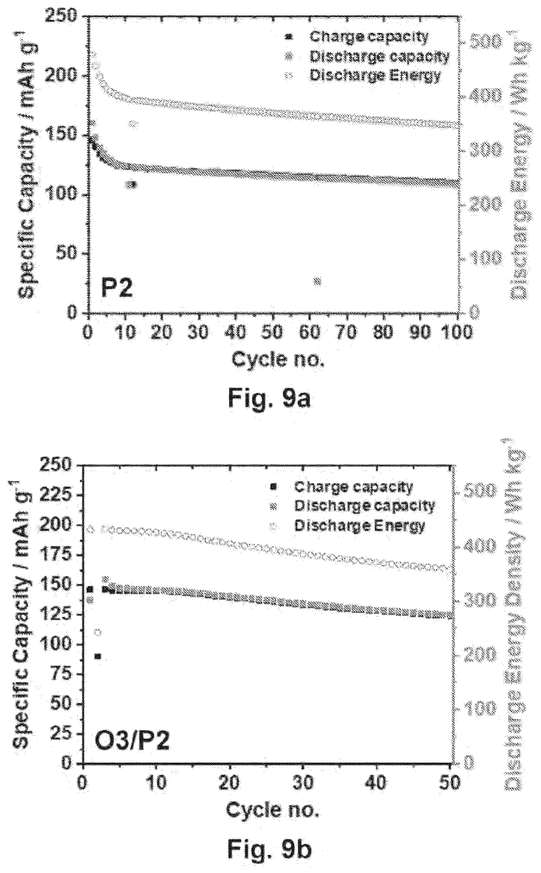

As discussed above, layered sodium metal oxide materials in accordance with the present invention displayed promising performance compared to other reported materials in the 2.5-4.2 V potential window. Further testing was carried out in wider potential windows to investigate the performance for high energy density cells. The results are shown in FIGS. 8a-b and 9a-b.

It was observed that the O3:P2 ratio had significant impact on the performance in different voltage windows, with the potential window needing optimising for each material studied. Nevertheless, high energy densities could be obtained from the pure phase P2 material when cycled in the potential window of 2.5-4.3 V, with an initial discharge capacity of 146 mAh g⁻¹. This corresponded to a cathode energy density of ˜480 W kg⁻¹, close to the energy density of the commercial Li-ion cathode material LiFePO₄ (LFP). Although rapid fade occurred during the initial seven cycles, performance soon stabilised with a 7^{th} cycle discharge capacity of 126 mAh g⁻¹ (energy density of ˜410 Wh kg⁻¹), of which 87% was retained by the 100th cycle. Crucially, 86% of the energy density was retained over the same cycle range, revealing that negligible voltage fade occurred, with the average discharge voltage remaining high at around 3.2 V throughout cycling. As well as high energy and stability, high energy efficiency (˜90%) was also shown, while the polarisation of 360 mV was relatively low for a material based on the Fe³⁺/Fe⁴⁺ redox couple. In addition, the initial coulombic efficiency of 91% is very suitable for full cell use, and the coulombic efficiency rapidly increased to over 99%, revealing that limited side-reactions occurred.

For the majority O3 bi-phasic material (O3/P2), a slightly lower potential window of 2.2-4.2 V was used for the high energy testing. An initial discharge capacity of 146 mAh g⁻¹ was achieved (430 W kg⁻¹, higher than the stable discharge energy obtained from the pure phase P2 material). Stable cycling was observed throughout the entire cycling range, with no initial fast fade. Overall, 86% of the initial discharge capacity was retained by the 50th cycle (126 mAh g⁻¹), demonstrating stable long-term cycling performance. In addition, the average voltage was high at just under 3 V, energy efficiency was ca. 89%, and the polarisation of 300 mV was even lower than the pure phase P2 material showed under high energy density testing.

The majority P2 phase bi-phasic material was also tested in both expanded potential windows. In the 2.5-4.3 V window, it displayed discharge capacities of 125 mAh g⁻¹ on the first cycle, 108 mAh g⁻¹ after 10 cycles, and 83 mAh g⁻¹ after 100 cycles, which corresponds to a 10^{th}-100^{th} capacity retention of 77%. This can be explained by higher polarisation in this material, which is likely linked to overcharging of the O3 part of the material up to 4.3 V, which may cause Fe migration and hence lower discharge capacities and cycling stability. In the 2.2-4.2 V potential window, an initial discharge capacity of 136 mAh g⁻¹ was returned, corresponding to an energy density of 407 W·kg⁻¹, with 82% retention over 50 cycles. Whilst this is high, it is lower than observed for the O3-rich bi-phasic material O3/P2, which suggests that in this voltage window, high O3 content is key to achieving high capacities.

These results show that is it crucial to appropriately match the O3: P2 ratio to the desired potential window to achieve the required performance, and further demonstrate the versatility of being able to tune the O3: P2 ratio to match the desired parameters, without changing the underlying chemistry.

### Example 2

A series of materials with different dopants was synthesised using a solid-state method and tested as positive electrodes for SIBs. The synthesized materials had the composition Na_{0.75}Mn_{0.4}Fe_{0.4}Ti_{0.1}M_{0.1}O₂, where M=Mg, Zn, Cu, Al, Si, or Zr. Other materials having a similar composition but not including M, or not including either Ti or M were also synthesized. In the solid state synthesis, stoichiometric amounts of sodium carbonate (2 wt % excess) was balled milled with Mn₃O₄, Fe₂O₃, TiO₂, MgO, ZnO, Cu₂O, Al₂O₃, SiO₂ and ZrO₂ (as appropriate depending on the desired composition) for 1 hour at 400 rpm. The resulting mixture was then pelletised and calcined under air for 12 h at 900° C. at a heating/cooling rate of 5° C./min. Once cooled to 250° C., the composition was removed and ground in a dry room before being transferred to an argon-filled glovebox.

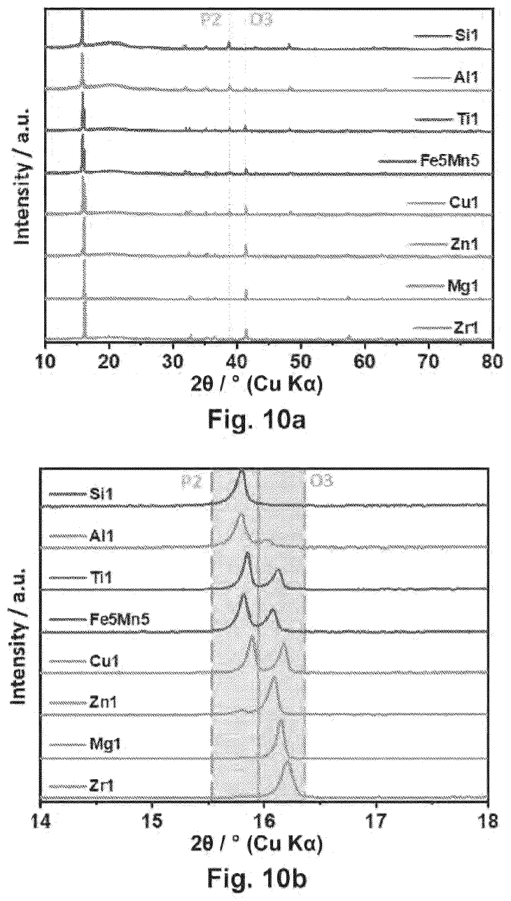

It was discovered that changing the M element in the series Na_{0.75}Mn_{0.4}Fe_{0.4}Ti_{0.1}M_{0.1}O₂, where M=Mg²⁺, Zn²⁺, Cu²⁺, Al³⁺, Si⁴⁺ or Zr⁴⁺, could change the crystal structure from pure P2 phase to pure O3 with a range of P2/O3 bi-phasic materials in between, as shown in FIGS. 10a-b.

It was found that the average ionic radius of the elements in the transition metal layer could act as a rough predictor as to whether a chemical change would lead to a material having a greater/lower O3 or P2 content. A lower average ionic radius in the transition metal layers was associated with an increase in the P2 content, while a higher average ionic radius in the transition metal layers was associated with an increase in the O3 content.

The materials were tested as the positive electrode for SIBs in the voltage window of 2.5-4.2 V, as shown in FIG. 11. Several materials (where M=Cu, Mg, Zr and O) showed superior performance compared to a reference material MFCu-622, which is a P2-type material having the composition Na_{0.75}Mn_{0.6}Fe_{0.2}Cu_{0.2}O₂, which was used as a benchmark due to being a high-performing, low-cost material.

### Example 3

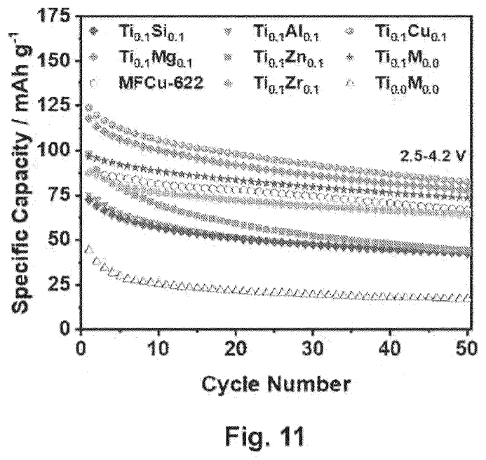

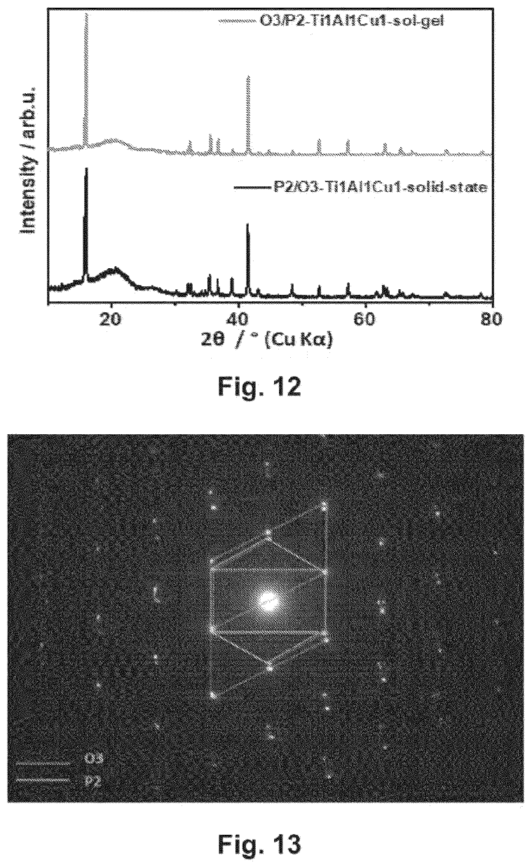

A material with the formula Na_{0.75}Mn_{0.35}Fe_{0.35}Ti_{0.1}Al_{0.1}Cu_{0.1}O₂ was designed, to take advantage of the respective benefits observed from the use of Cu and Al dopants in Examples 1 and 2. Two materials with the same chemical composition, Na_{0.75}Mn_{0.35}Fe_{0.35}Ti_{0.1}Al_{0.1}Cu_{0.102}, were synthesised using the sol-gel and solid state synthetic routes used in Examples 1 and 2, respectively. The solid-state route led to a bi-phasic product with a significantly larger P2 content compared to the sol-gel route, showing the influence that the choice of synthetic route has on the O3: P2 phase ratio (as shown in FIG. 12).

To study the distribution of the O3 and P2 phases within the materials, i.e. to investigate whether the two phases (O3 and P2) exist as separate particles, or as intergrowths on the same particles, transmission electron microscopy (TEM) coupled with selected area electron diffraction (SAED) was used. FIG. 13 shows the resulting SAED pattern from one of the studied particles, which clearly showed the presence of both the O3 and P2 phases existing within one particle. This shows that the two phases exist as intergrowths on the same particles, which is likely to lead to additional benefits electrochemically due to reduced overall strain/volume changes during cycling, compared to a physical mixture of pure phase particles.

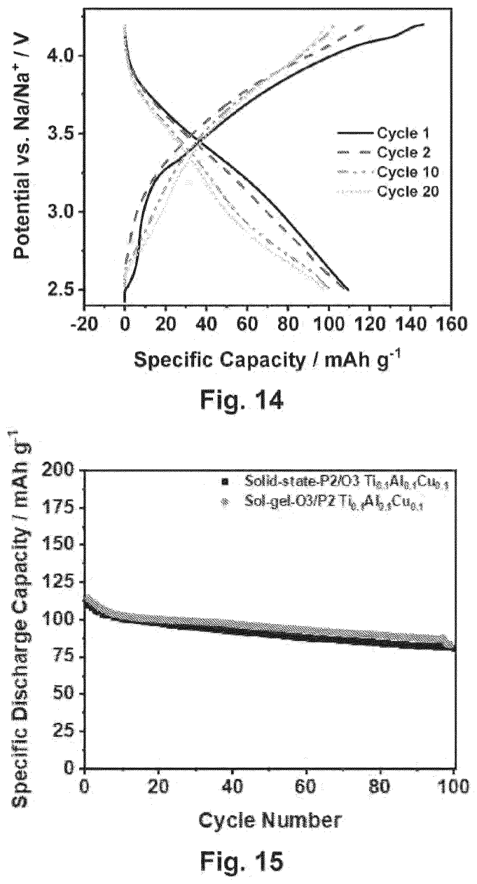

When cycled between 2.5-4.2 V at 25 mA g⁻¹, both sol-gel and solid-state materials showed promising performance, with initial discharge capacities of 114 and 109 mAh g⁻¹ and capacity retentions of 78 and 76% after 100 cycles, respectively (FIGS. 14-15, where FIG. 14 shows the load curves for the solid-state material).

### Example 4

O3P2 and P2/O3 materials of compositions in which b≠c and/or d≠e were synthesised and tested. Two materials comprising copper and aluminium dopants were synthesised with the following compositions:
Na_{0.75}Mn_{0.45}Fe_{0.28}Ti_{0.05}Al_{0.05}Cu_{0.17}O₂ (O3P2 material comprising 77% O3 phase and 23% P2 phase); and
Na_{0.74}Mn_{0.50}Fe_{0.25}Ti_{0.05}Al_{0.05}Cu_{0.15}O₂ (P2O3 material comprising 92% P2 phase and 8% O3 phase).

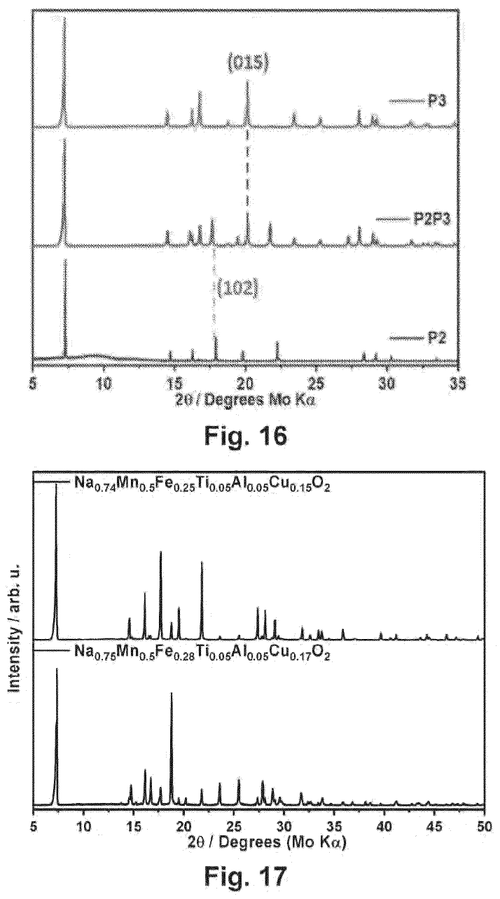

These materials were synthesised using the sol-gel synthetic routes used in Examples 1 and 2, respectively. FIG. 16 shows powder X-ray diffraction patterns for the synthesised materials, showing the presence of O3 and P2 phases.

When cycled between 2.5-4.2 V at 25 mA g⁻¹, both materials showed promising performance, with initial discharge capacities of about 100 and about 75 mAh g⁻¹ and all materials exhibiting a high capacity retention over at least 15 cycles (FIG. 17).

### Example 5

O3P2 materials of compositions in which b≠c and/or d≠e were synthesised and compared with material in which b=c and d=e. Five materials comprising copper dopants were synthesised with the following compositions:
Na_{0.74}Mn_{0.45}Fe_{0.28}Ti_{0.05}Cu_{0.22}O₂ (O3P2 material comprising 85% O3 phase and 15% P2 phase);
Na_{0.72}Mn_{0.35}Fe_{0.25}Ti_{0.20}Cu_{0.20}O₂ (O3P2 material comprising 78% O3 phase and 22% P2 phase);
Na_{0.75}Mn_{0.50}Fe_{0.25}Ti_{0.10}Cu_{0.15}O₂ (O3P2 material comprising 60% O3 phase and 40% P2 phase);
Na_{0.72}Mn_{0.35}Fe_{0.30}Ti_{0.20}Cu_{0.15}O₂ (O3P2 material comprising 67% O3 phase and 33% P2 phase); and
Na_{0.80} Mn_{0.30}Fe_{0.30}Ti_{0.20}Cu_{0.20}O₂ (O3P2 material comprising 88% O3 phase and 12% P2 phase).

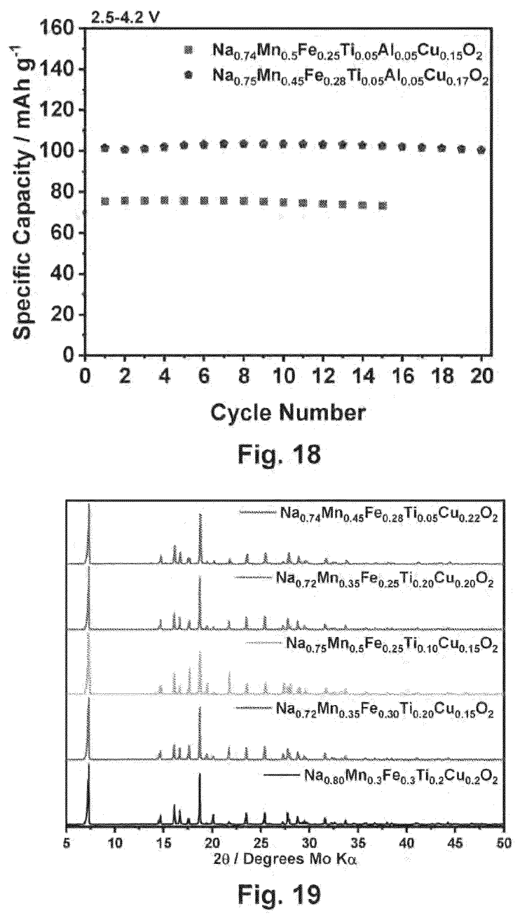

These materials were synthesised using the sol-gel-synthetic routes used in Examples 1 and 2, respectively. FIG. 18 shows powder X-ray diffraction patterns for the synthesised materials, showing the presence of O3 and P2 phases.

When cycled between 2.5-4.2 V at 25 mA g⁻¹, all materials showed promising performance, with initial discharge capacities ranging from about 80 to about 97 mAh g⁻¹, and most materials exhibiting a high capacity retention over at least 40 cycles (FIG. 19).

### Example 6

P2O3 materials of compositions in which b≠c and d≠e were synthesised comprising copper dopants. Three materials were synthesised with the following compositions:
Na_{0.72}Mn_{0.45}Fe_{0.25}Ti_{0.10}Cu_{0.20}O₂ (P2O3 material comprising 71% P2 phase and 29% O3 phase);
Na_{0.73}Mn_{0.50}Fe_{0.25}Ti_{0.10}Cu_{0.15}O₂ (P2O3 material comprising 86% P2 phase and 14% O3 phase); and
Na_{0.72}Mn_{0.39}Fe_{0.40}Ti_{0.05}Cu_{0.16}O₂ (P2O3 material comprising 84% P2 phase and 16% O3 phase).

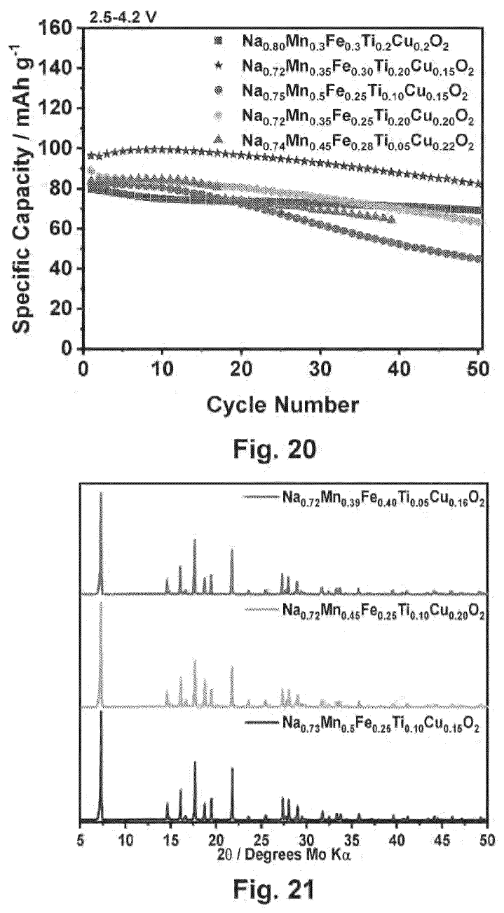

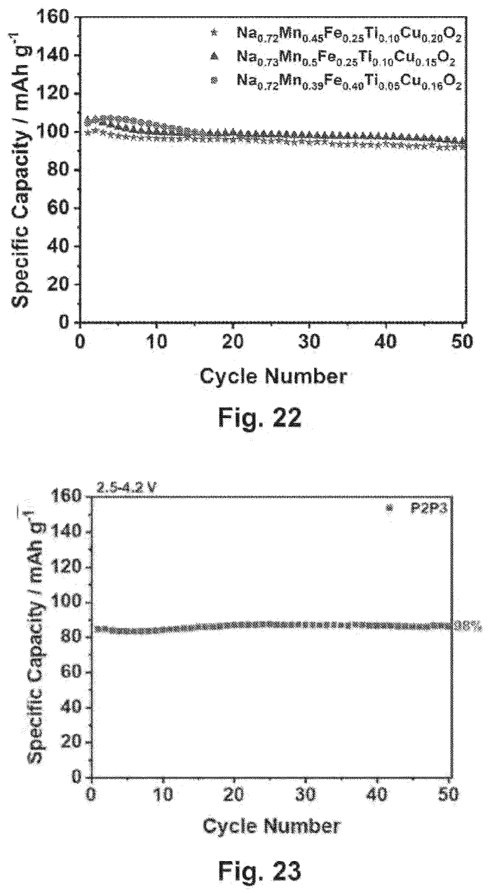

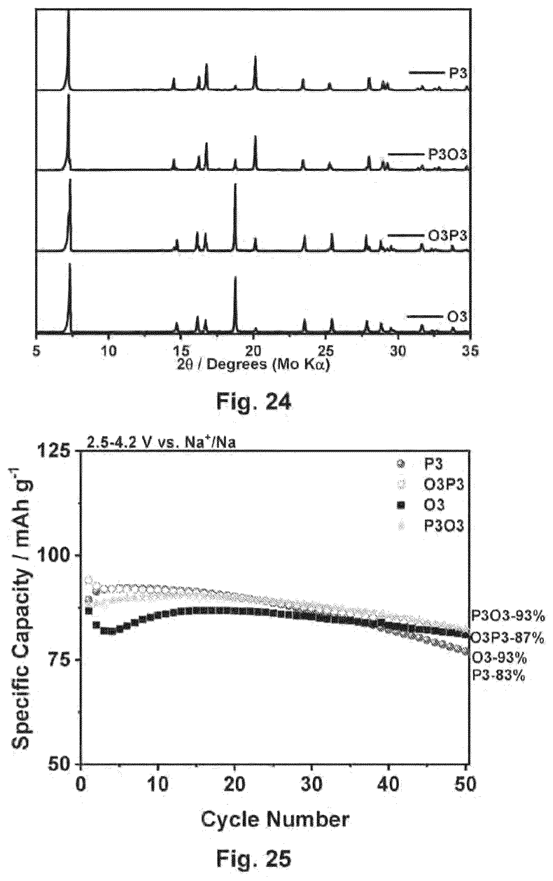

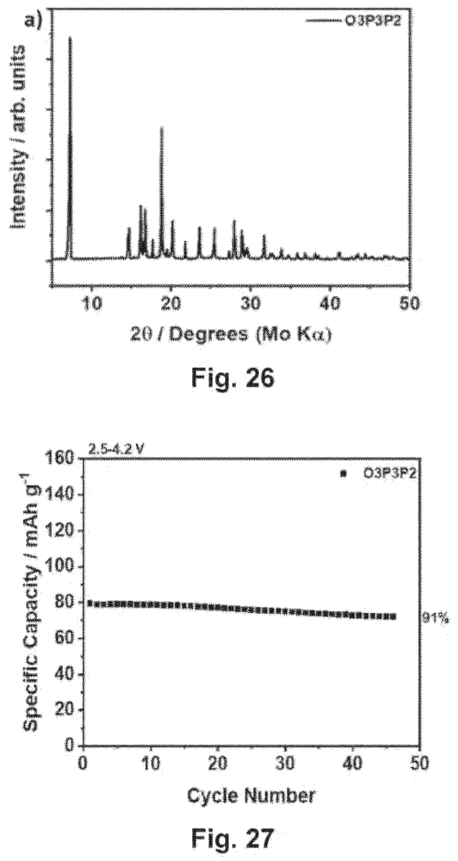

These materials were synthesised using the sol-gel-synthetic routes used in Examples 1 and 2, respectively. FIG. 20 shows powder X-ray diffraction patterns for the synthesised materials, showing the presence of O3 and P2 phases.

When cycled between 2.5-4.2 V at 25 mA g⁻¹, all materials showed promising performance, with initial discharge capacities ranging from about 100 to about 105 mAh g⁻¹, and all materials exhibiting a high capacity retention over at least 15 cycles and in some cases up to 50 cycles (FIG. 21).

### Example 4

A series of mixed phase materials, which include the P3 phase in addition to the O3 and/or P2 phases, were developed with phase compositions including P2P3, O3P3 and O3P2P3.

The P2P3 phase combination offers materials in which all sodium ions occupy prismatic sites, even at higher sodium contents such as Na_{0.80}Mn_{0.4}Fe_{0.3}Ti_{0.15}Cu_{0.15}O₂, (typical P3 or P2 sodium contents are around 0.67). Consequently, the P2P3 phase enables high voltage, good rate capability and good cycle life. The P2P3 Na_{0.80}Mn_{0.4}Fe_{0.3}Ti_{0.15}Cu_{0.15}O₂ material was synthesised using the sol-gel synthetic route and the same reagents as used in Example 1 (with the exception that ammonium nitrate was not used). Calcination was carried out under air for 5 hours at 500° C., followed by 12 hours at 1000° C., and then 6 hours at 500° C., using a heating/cooling rate of 5° C./min. The material exhibited a discharge voltage of up to 3.45 V (compared to 3.2-3.3 V for O3P2 materials) and 98% capacity retention up to 50 cycles (see FIG. 23).

Single phase O3-type and P3-type materials convert into one another during cycling (i.e. O3 single phase materials convert into P3, while P3 single phase materials convert into O3). These conversions are associated with volume changes and capacity fade. Consequently, the O3P3 phase combination offers materials exhibiting greater cycling stability by reducing the driving force for conversion between phases. Bi-phasic O3P3 materials (specifically O3P3-Na_{0.77}Mn_{0.4}Fe_{0.4}Ti_{0.1}Cu_{0.1}O₂ and P3O3-Na_{0.85}Mn_{0.4}Fe_{0.4}Ti_{0.1}Cu_{0.1}O₂) were synthesised using the sol-gel synthetic route and the same reagents as used in Example 1 (with the exception that ammonium nitrate was not used). For O3P3-Na_{0.77}Mn_{0.4}Fe_{0.4}Ti_{0.1}Cu_{0.1}O₂, calcination was carried out under air for 5 hours at 500° C., followed by 12 hours at 1000° C. using a heating/cooling rate of 5° C./min. For P3O3-Na_{0.85}Mn_{0.4}Fe_{0.4}Ti_{0.1}Cu_{0.1}O₂, calcination was carried out under air for 5 hours at 500° C., followed by 5 hours at 1000° C. using a heating/cooling rate of 5° C./min. The properties of the bi-phasic O3P3 materials were compared with O3 and P3 single phase materials. The mixed phase P3 and O3 materials delivered higher capacities than the O3 single phase material, with greater cycling stability than the P3 single phase material (see FIG. 25).

All three phases were combined into a single material: O3P3P2 Na_{0.85}Mn_{0.4}Fe_{0.3}Ti_{0.15}Cu_{0.15}O₂, which was synthesised using the sol-gel synthetic route and the same reagents as used in Example 1 (with the exception that ammonium nitrate was not used). Calcination was carried out under air for 5 hours at 500° C., followed by 12 hours at 1000° C., using a heating/cooling rate of 5° C./min. The tri-phasic material allowed for high sodium ion contents and long cycle life (see FIG. 27).

1. A composition having the general formula:
NaₐMn_{b}Fe_{c}Ti_{d}MₑO₂,
wherein:
M comprises one or more elements selected from the group consisting of aluminium, magnesium, zinc, copper, silicon, and zirconium; and
wherein:
0.5<a≤1;
0.1≤b≤0.7;
0.1≤c≤0.7;
0<d≤0.3; and
0<e≤0.5,
wherein:
the composition is a layered sodium metal oxide material having at least a first phase and a second phase, wherein each phase is different and independently comprises one or more P2-type structures, one or more O3-type structures, or one or more P3-type structures.

2. The composition of claim 1, wherein:
(i) the first phase comprises one or more P2-type structures and the second phase comprises one or more O3-type structures;
(ii) the first phase comprises one or more P2-type structures and the second phase comprises one or more P3-type structures; or
(iii) the first phase comprises one or more P3-type structures and the second phase comprises one or more O3-type structures.

3. The composition of claim 1, wherein:
(i) the first phase comprises one or more P2-type structures and the second phase comprises one or more O3-type structures; or
(ii) the first phase comprises one or more P2-type structures and the second phase comprises one or more P3-type structures.

4. The composition of claim 1, wherein the first phase comprises one or more P2-type structures and the second phase comprises one or more O3-type structures.

5. The composition of claim 1, wherein the composition consists of:
(i) a first phase comprising one or more P2-type structures and a second phase comprising one or more O3-type structures;
(ii) a first phase comprising one or more P3-type structures and a second phase comprising one or more O3-type structures;
(iii) a first phase comprising one or more P2-type structures, a second phase comprising one or more O3-type structures, and a third phase comprising one or more P3-type structures; or
(iv) a first phase comprising one or more P2-type structures and a second phase comprising one or more P3-type structures.

6. The composition of claim 1, wherein:
0.6≤a≤0.9; and/or
0.2≤b≤0.5; and/or
0.2≤c≤0.5; and/or
b=c; and/or
d=e.

7. The composition of claim 1, wherein M comprises any one or more elements selected from the group consisting of aluminium, copper, magnesium, and zirconium.

8. The composition of claim 1, wherein M comprises one or more elements selected from the group consisting of magnesium, zinc, copper, aluminium, silicon, and zirconium.

9. The composition of claim 1, wherein M comprises aluminium and copper.

10. The composition of claim 1, having the general formula:
NaₐMn_{b}Fe_{c}Ti_{d}AlₘM′ₙO₂,
wherein:
M′ comprises one or more elements selected from the group consisting of magnesium, zinc, copper, aluminium, silicon, and zirconium; and
wherein:
0<m≤0.2; and
0<<0.2.

11. The composition of claim 1, wherein the layered sodium metal oxide material comprises from 0.1 to 99.9 wt % of the first phase and from 0.1 to 99.9 wt % of the second phase.

12. An electrode comprising the layered sodium metal oxide material of claim 1.

13. An energy storage device comprising the layered sodium metal oxide material of claim 1, wherein the energy storage device is a sodium-ion battery.

14. A method of forming a layered sodium metal oxide material as defined in claim 1 via a sol-gel route, the method comprising:
(a) providing a metal salt solution, the metal salts including salts of Na, Mn, Fe, and M;
(b) mixing a Ti source with the metal salt solution;
(c) mixing a gelator with the metal salt solution to form a sol-gel solution;
(d) increasing the pH of the sol-gel solution;
(e) heating the sol-gel solution to form a gel; and
(f) subjecting the gel to calcination to obtain the layered sodium metal oxide material;
wherein M comprises one or more elements selected from the group consisting of aluminium, magnesium, zinc, copper, silicon, and zirconium.

15. The method of claim 14, wherein the gelator is a carboxylic acid.

16. The method of claim 14, wherein the stoichiometric ratio of gelator to metal salts is 1:1.

17. The method of claim 14,
wherein step (d) includes increasing the pH of the sol-gel solution to a pH of 6 to 10.

18. The method of claim 14,
wherein step (e) includes heating the sol-gel solution to a temperature from 60 to 100° C.

19. The method of claim 14, wherein step (f) includes subjecting the gel to calcination in an oxidising atmosphere.

20. The method of claim 14, wherein step (f) includes:
(g) calcining the gel at a first temperature of 400 to 600° C., then
(h) calcining the gel at a second temperature of 600 to 1200° C., and, where the layered sodium metal oxide material comprises one or more P3-type structures,
(i) calcining the gel at a third temperature of 400 to 600° C.

21. The method of claim 20, wherein step (g) includes calcining the gel at the first temperature for 2 to 6 hours and step (h) includes calcining the gel at the second temperature for 0.5 to 20 hours.

22. A method of forming a layered sodium metal oxide material as defined in claim 1 via a solid-state route, the method comprising:
a) providing a sodium source,
b) providing Mn₃O₄, Fe₂O₃, TiO₂,
c) providing an M oxide, wherein M comprises one or more elements selected from the group consisting of aluminium, magnesium, zinc, copper, silicon, and zirconium;
d) milling the compounds of steps a), b), and c) together;
e) pelletising the mixture from step d);
f) calcining the pelletised mixture from step e).
